(19) United States
(12) Patent Application Publication
(10) Pub. No.: US 2016/0024227 A1
(43) Pub. Date: Jan. 28, 2016

(54) METHOD FOR BREAKING DOWN LIGNOCELLULOSIC BIOMASS

(71) Applicant: STUDIENGESELLSCHAFT KOHLE MBH, Mülheim an der Ruhr (DE)

(72) Inventors: Mats KÄLDSTRÖM, Mülheim an der Ruhr (DE); Roberto RINALDI, Mülheim an der Ruhr (DE); Niklas MEINE, Düsseldorf (DE); Ferdi SCHÜTH, Mülheim an der Ruhr (DE)

(73) Assignee: STUDIENGESELLSCHAFT KOHLE MBH, Mülheim an der Ruhr (DE)

(21) Appl. No.: 14/774,818

(22) PCT Filed: Mar. 6, 2014
(86) PCT No.: PCT/DE2014/100080

§ 371 Date: Sep. 11, 2015

(30) Foreign Application Priority Data
Mar. 12, 2013 (DE) 10 2013 102 452.1

(51) Int. Cl. C08B 1/00

(52) U.S. Cl. CPC C08B 1/003

(57) ABSTRACT

The present invention relates to a method for breaking down lignocellulose biomass. In said method, acid-impregnated lignocellulose biomass, e.g., beech wood, pine wood or sugarcane bagasse, is subjected to a mechanical treatment and the obtained break-down residues are fed to a process of separation into water-soluble and water-insoluble components.

This application is a 371 of International Patent Application No. PCT/DE2014/100080, filed Mar. 6, 2014, which claims foreign priority benefit under 35 U.S.C. §119 of the German Patent Application No. 10 2013 102 452.1, filed Mar. 12, 2013, the disclosures of which are incorporated herein by reference.

The present invention relates to a process for breaking down (digesting) lignocellulosic biomass, in which lignocellulose-containing starting materials are decomposed into degradation products, the soluble fractions of the degradation products being placed in aqueous solution and the water-insoluble fractions, which essentially consist of lignin, being separated out in a precipitated form.

A comprehensive amount of research has been carried out over a long period of time in the prior art into the use of biomass as a base material for fuels and for chemical basic materials. Cellulose and lignin, as the major components of lignocellulose-containing biomasses, are viewed as possible raw materials in this regard. In order to obtain suitable and products which can be processed, the lignocellulose has to be broken down into smaller molecules.

From time immemorial, lignocellulose has been used in the form of wood as a construction material and fuel. The cellulose fraction is used for the manufacture of paper. Lignin is usually viewed as a waste product and impurity which should be present in the used lignocellulose in as small a quantity as possible. Occasionally, the prior art has sought to use lignocellulose from grain, straw, reeds, wood, paper and cellulose-containing waste as a renewable raw material for various chemical base materials. In particular, the phenol-like compounds in lignin can be considered as possible raw materials for recycling.

A large number of documents are known in the prior art which are concerned with exploiting biomass. For the most part they concern processes for acid-catalysed hydrolysis of cellulose-containing biomass.

Thus, US 2003/199049 discloses the impregnation of biomass with a dilute acid, drying and hydrolysis with the addition of steam.

EP 0 081 678 A1 also discloses the impregnation of biomass with dilute sulphuric acid, dewatering and hydrolysis with the addition of steam.

DE 33 12 450 A1 discloses the impregnation of a cellulose-containing material with dilute acid, drying of the material and hydrolysis. The material may be defibrated between the pre-hydrolysis and main hydrolysis.

In addition, US 2010/126501 discloses the acid-catalysed hydrolysis of biomass. In that document, cellulose fibres are processed into quasi-molten heteropolyacids. The ratio between the fibrous material and the heteropolyacid is super-equimolar, 1:1-1:4, and the reaction is carried out at temperatures of up to 120° C. The substrate undergoes a hydrolysis after suspension with cellulose fibres in the pseudo-molten heteropolyacids.

WO 03/046227 discloses a process for the treatment of a wood mass with a dilute acid in solution, wherein the mechanical forces used for pre-treatment of the wood are used to destroy the structure of the wood and then to compress the substrate in the toothed disk mill in order to reduce the water content in the material and to facilitate the absorption of the dilute acid into the interior of the structure of the wood which has been broken open. The hydrolysis here is carried out after contacting the fibres with steam at temperatures of 160° C.

GB 376 323 A concerns a process wherein the absorption of an organic solvent in a ratio by weight of 20-200% by weight of the substrate, transfer of the impregnated substrate into a rotary drum and addition of hydrochloric acid vapour is carried out in order to decompose the substrate. The products obtained in accordance with this process are insoluble in organic solvents and in water.

Furthermore, U.S. Pat. No. 4,292,089 discloses a suspension of wheat straw in a 40% by weight hydrochloric acid solution in a rotary evaporator, wherein hydrogen chloride gas is introduced into the suspension so that the concentration of hydrogen chloride is in the saturation region. In accordance with this treatment, the wheat straw is dissolved in the concentrated hydrochloric acid solution and no mechanical forces are employed to depolymerize the lignocellulosic substrate.

Lignocellulose is also exploited as a raw material for biofuels along with the production of bioethanol.

Thus, EP 2 468 875 concerns an integrated biotechnical process which produces biofuel and/or starting material for biofuel and uses a microorganism which contains enzymes. Here, microorganisms are cultivated and a supernatant or a fraction enriched with protein which comprises catalytically active enzyme(s) is employed.

Further, EP 2 479 821 describes a process for the treatment of lignocellulosic material which comprises the steps of: comminuting the lignocellulosic substrate, mixing the particles obtained with water and dispersing the mixture using a colloid mill to form a suspension, high pressure homogenisation of the suspension in order to obtain particles with a particle diameter of 10-40 μm as well as buffers of the suspension with sodium acetate and acetic acid buffer solution, and then adding the enzymes cellulase and xylanase-glucosidase and carrying out the enzymolysis for 36-72 hours.

The known prior art processes for processing biomass, including obtaining lignin from lignocellulosic biomass, can be improved, however, as regards simplifying the process and its yields. These processes are usually expensive both as regards equipment and as regards process conditions.

Thus, the aim of the present invention was to provide a process by means of which lignin and decomposition products can be obtained in high yields in a simple and efficient manner from lignocellulose-containing materials.

Recognising that a pre-treatment could be necessary for the efficient transformation of lignocellulose, the inventors have discovered that liquid or gas phase infiltration of the lignocellulose-containing starting materials, also termed impregnation in the context of the invention, using a catalytic quantity of a strong acid (for example HCl, H₂SO₄ etc.), along with the application of mechanical forces to the starting materials which have been impregnated with acid and preferably dried, is a very important step in obtaining digestion products which are easy to separate into water-soluble and water-insoluble products.

Accordingly, the invention provides a process for digesting lignocellulosic biomass in which, in a first step, lignocellulosic starting materials are infiltrated with or impregnated with an acid in the liquid or gaseous phase; in a second step, the starting materials which have been impregnated/loaded and preferably dried are brought into contact under the action of mechanical energy, wherein the lignocellulosic materials are transformed into a water-soluble digestion residue; in a third step, the digestion residue is dissolved in water or in a water-miscible solvent and hydrolysed. In this respect, the digestion residue is separated into water-soluble fractions and water-insoluble fractions.

A representation of the process for fractionation of plant biomass into water-soluble monosaccharides and lignins is shown in FIG. 10.

The process of the invention for the digestion of lignocellulosic biomass comprises, in a first step, treatment of the lignocellulosic starting materials with an acid which may be present in the liquid or gaseous phase and which is used to infiltrate or impregnate the starting materials. In a second step, the acid-impregnated/loaded and preferably dried starting materials are brought into contact under the action of mechanical energy, wherein the mechanical treatment is carried out for at least the length of time required for more than 60% by weight of the degradation or decomposition products of the lignocellulosic material, preferably more than 70% by weight, more preferably more than 80% by weight, in particular more than 90% by weight with respect to the lignocellulosic material used, to be water-soluble. Depending on the starting material and quantity, this mechanical treatment may be carried out for up to several hours. The digestion residue formed is then taken up in a third step in water, in a solvent which is miscible in water or mixtures thereof, and the dispersion or solution obtained is heated to a temperature of more than 40° C., in particular more than 60° C., more particularly more than 80° C. and advantageously more than 100° C. in a reactor which may be operated continuously, or in an autoclave up to 200° C., particularly preferably in the range 100° C. to 140° C., and over a period of up to 24 hours.

In the simplest case, the digestion residue is taken up in water or a solvent which is miscible with water such as methanol, ethanol or acetone, which may be present as a mixture and also as a mixture with water in an amount of up to 40% by weight, and the water-soluble portions are dissolved. The fractions, which essentially consist of lignin, precipitate out of the digestion solution as they are insoluble in water, preferably by heating the digestion solution, and are separated out in the precipitated form.

The water-soluble portions essentially consist of carbohydrates such as cellobiose, glucose and xylose.

In this regard, the lignocellulosic material is not restricted to already purified materials; even untreated natural products such as wood, for example spruce, can be transformed in yields of at least 75% or 87% after 2 hours of milling; beechwood or sugarcane bagasse can even be transformed, in yields of more than 99%, into water-soluble products after milling for 2 hours.

When carrying out the process of the invention, an acid selected from inorganic acids, organic acids or mixtures thereof is used. In this regard, the acid is used in the process of the invention in catalytic quantities. Preferably, the acid is used in a quantity of 0.0001 to 1 mmol, in particular 0.001 to 1 mmol, more particularly 0.01 to 1 mmol, respectively per gram of lignocellulosic material.

Impregnating the lignocellulose-containing substrates with a strong acid may be carried out with a dilute acid solution (0.0001 to 6 mol/l) of the acid in a solvent with a low boiling point (for example dimethylether, diethylether, methylethylether, tert-butylmethylether, acetone, pentane, hexane, heptane, supercritical carbon dioxide, ethyl acetate, methyl acetate, methanol, dichloromethane, etc.) or mixtures thereof, wherein the solvent can be readily removed in a subsequent step of the process, for example by applying a partial vacuum or by adding heat.

In order to be able to avoid a process step for removing the solvent, the substrate may alternatively be treated with a gaseous acid. In this case, the lignocellulosic material can be exposed to gaseous HCl, SO₃ or other gaseous acids. If desired, however, a combination of infiltration/soaking with impregnation using gas may also be carried out, including with different acids.

Particularly good transformation results are obtained if the inorganic acid has a pKa of <3; preferably, the pKa of the acid is between −14 and 2. Suitable examples for inorganic acids are mineral acids such as sulphuric acid, sulphur dioxide, sulphur trioxide, hydrochloric acid, phosphoric acid, phosphotungstic acid and nitric acid, although nitric acid is less preferred.

Particularly good transformation results are obtained if the organic acid has a pKa of <3; preferably, the pKa of the acid is between −14 and 2. Suitable examples of organic acids are benzosulphonic acids and their derivatives, haloalkanecarbonic acids such as trifluoroacetic acid, or methanesulphonic acid, trifluoroacetic acid and oxalic acid, and derivatives thereof.

Mixtures of the above acids may also be used. Acids with a pKa of less than −2 are preferred.

In order to carry out the process of the invention, it has proved to be significant if the acid is not immediately brought into contact with the lignocellulose, but if in a first step of the process, the lignocellulosic material is impregnated with a solution of the acid in a suitable solvent and/or with a gaseous acid. If the soaking is carried out in a solution, the solvents or mixtures which are used are such that they do not have a negative influence on the reaction; examples are water and organic solvents such as diethylether, dichloromethane, ethanol, methanol, THF, acetone, benzene, light hydrocarbons (for example hydrocarbons containing four to seven carbon atoms) and any other polar or nonpolar solvent in which the acid employed is soluble, or which can be used to provide good admixing of lignocellulose and acid in a dispersion, and which has a boiling point of 100° C. and below. In this possible process step, the solution or dispersion of acid is mixed with the cellulose-containing material and allowed to stand for a period of up to several hours, particularly up to 2 hours.

Prior to mechanical treatment of the lignocellulosic material, the solvent should preferably be removed again, for example by filtration and/or evaporation. In particular, when a low boiling point solvent with a boiling point of 30° C. to 80° C. at normal pressure is used, this can easily be removed again, either by warming slightly and/or by applying a partial vacuum. The acids, which normally have a higher boiling point, remain on the lignocellulosic material. Next, mechanical treatment of the lignocellulosic material is carried out in the presence of the acid. It has been shown that the degree of transformation of the lignocellulosic material can be substantially increased by impregnating the lignocellulosic material with inorganic and/or organic acid in the presence of a solvent.

After removing the solvent, the lignocellulosic material which has been impregnated with acid and preferably dried has a residual moisture content of less than 20% by weight, in particular less than 16% by weight, with respect to the total weight of the impregnated lignocellulosic material. Preferably, in the further process, a lignocellulosic material is used which has a residual moisture content in the range 2% to 10% by weight with respect to the total weight of the impregnated lignocellulosic material, which if necessary can be obtained by drying.

The mechanical treatment of the impregnated and dried lignocellulosic substrates may, for example, be carried out by milling, extruding or kneading or by the application of high energy mechanical waves such as ultrasound, for example with an ultrasonic mill. Mills (their mode of operation does not limit the invention) which may also be used are those which comminute the material to be milled by using milling bodies, examples of which are vibration mills, agitator mills, agitator ball mills, ball mills etc., hammer mills or the like, in which the material to be comminuted is comminuted using kinetic energy of the particles; examples of these are impact mills and impact crushers. Mills which can be used for large scale techniques are preferred, such as hammer mills, tube mills and also ball mills. The extruder which may be used may be any extruder which is known in the art. If the process of the invention is carried out in a ball mill, for example in a planetary ball mill, then rotational speeds of 400 to 1200, preferably 800 to 1000 rpm have proved to be suitable. The rotational speed may be lower for large-scale units, but the skilled person will be able to set the rotational speed as a function of the material used and the mill employed so that an optimized result can be obtained. The reaction period, i.e. the time during which mechanical treatment is carried out, is usually 0.01 to 24 hours, but periods of 1.5 to 12, in particular 2 to 6 hours are sufficient to mix products with a molecular weight of less than 2000 Da with the aim of obtaining complete or at least high yields of water-soluble products.

The mechanical treatment of the invention is carried out for at least the time required for more than 60% by weight of the degradation or decomposition products of the lignocellulosic material, preferably more than 70% by weight, in particular more than 80% by weight, more particularly more than 90% by weight with respect to the lignocellulosic material employed, to be soluble in water. As a function of the equipment used for the mechanical treatment, the acid catalyst and the quantity of the lignocellulosic material used, this is as a rule obtained with a treatment period of 2 to 6 hours, wherein this process period can be determined by the skilled person with a knowledge of the unit being used and the lignocellulosic materials being used.

As shown above, almost quantitative transformations of the lignocellulosic materials into water-soluble products can be obtained with the process of the invention. Water-soluble cellulose oligomers, cellobiose and further products are obtained, wherein the formation of by-products (for example 5-hydroxymethylfurfural, furfural, levulinic acid, etc.) can be avoided to a large extent.

The products obtained, also denoted lignocellulosic decomposition products in the context of the invention, in particular after milling in a ball mill, are in the powder form, and are dissolved in water.

Heating the aqueous solution of the degradation or decomposition products of the cellulose-containing material to a temperature of more than 80° C., particularly between 100° C. and 200° C., in particular 120° C. to 160° C., more particularly between 130° C. and 150° C., is carried out for a period of 0.005 to 24 hours, in particular 0.25 to 12 hours, more particularly 2 to 6 hours and then the solid residues obtained, essentially lignin, are separated by filtration.

Compared with lignins obtained in accordance with the prior art, for example using the kraft or sulphite process which contain up to 9% by weight of sulphur, the lignins obtained in accordance with the invention have a low sulphur content of less than 0.05% by weight. In principle, different technical lignins differ in several of their properties, which could have an influence on their use. The essential difference is in the molecule size: kraft lignin has a molar mass of 2000 to 3000 g/mol, while lignosulphonates have molar masses of 20000 to 50000 g/mol. That for Organosolv lignin is 1000 to 2000 g/mol. Lignosulphonates also have a sulphur content of 4% to 8% and few phenolic hydroxyl groups (—OH), as opposed to 1% to 1.5% as a sulphur content and many phenolic hydroxyl groups with kraft lignin and many phenolic hydroxide ions (OH⁻) with no sulphur content with Organosolv lignin.

In contrast to lignin from the Organosolv process, the lignin obtained in accordance with the invention has a higher molecular mass. Because of its properties, in particular the low sulphur content, the lignin obtained in accordance with the invention can be used in higher value applications, for example for the manufacture of plastics. At the same time, however, in contrast to the Organosolv process in which water-insoluble polymeric saccharides are obtained, water-soluble saccharides such as glucose, xylose, etc. are obtained.

Because the products formed in the mechanocatalytic process are completely soluble in water, this advantage means that processing the product mixture in a continuous reactor using a solid catalyst can be carried out; this is a major advantage from the process technology point of view. The process of the invention can clearly also be carried out batchwise.

The present invention will now be explained in more detail in the following examples which do not in any way limit the invention.

### EXAMPLES

### Example 1

Beechwood shavings were processed to a powder using a kitchen mixer. The powder was sieved and the particles under 250 μm were used as described below.

Beechwood shavings (10 g) were dispersed in diethyl ether (150 mL) and sulphuric acid (0.52 mL, 95-97%, a commercially available product from J T Baker, USA) was added dropwise. The suspension was stirred for 1 hour before the solvent was removed under reduced pressure. Further, the powder which had been impregnated with acid and dried (1 g) was milled for 2 hours in a steel bowl with steel balls (5 steel balls; individual weight 3.95 g) in a Pulverisette P7 from Fritsch. The rotational speed of the main disk was 800 rpm. A sample of the powder obtained was dissolved in water and examined using HPLC analysis. The powder obtained was completely water-soluble and produced a clear reddish-brown solution.

The powder obtained (0.9 g with acid) was dissolved in water (1.35 mL). The solution was heated for 1 hour to 40° C. The solid obtained thereby (lignin) was separated by filtration or centrifuging.

The solid was washed 6 times with 25 mL of water each time. The solid was then dried for 24 hours under vacuum at 60° C. The dry solid was weighed. The chemical composition of the solid was investigated by means of elemental analysis and infrared spectroscopy. The filtrate of the combined aliquots was analysed using HPLC.

The yield for the solid residue was 0.041 g. Ultimate analysis of the solid residues produced the following results: 47.6% carbon, 6.2% hydrogen, 0.3% nitrogen, 0.0% sulphur and 46.3% oxygen (by difference). In the aqueous solution, the yields were as follows: cellobiose 6.3%, glucose 3.9% and xylose 7.1%. The yields of glucose and cellobiose were with respect to the hexose fraction in the original biomass. Similarly, the yield of xylose was with respect to the pentose fraction in the original biomass.

### Example 2

Beechwood shavings were processed to a powder using a kitchen mixer. The powder was sieved and the particles under 250 μm were used as described below.

Beechwood shavings (10 g) were dispersed in diethyl ether (150 mL) and sulphuric acid (0.52 mL, 95-97%, a commercially available product from J T Baker, USA) was added dropwise. The suspension was stirred for 1 hour before the solvent was removed under reduced pressure. Further, the powder which had been impregnated with acid and dried (1 g) was milled for 2 hours in a steel bowl with steel balls (5 steel balls; individual weight 3.95 g) in a Pulverisette P7 from Fritsch. The rotational speed of the main disk was 800 rpm. A sample of the powder obtained was dissolved in water and examined using HPLC analysis. The powder obtained was completely water-soluble and produced a clear reddish-brown solution.

The powder obtained (0.9 g with acid) was dissolved in water (9 mL). The solution was heated for 1 hour to 60° C. The solid obtained thereby (lignin) was separated by filtration or centrifuging.

The solid was washed 6 times with 25 mL of water each time. The solid was then dried for 24 hours under vacuum at 60° C. The dry solid was weighed. The chemical composition of the solid was investigated by means of elemental analysis and infrared spectroscopy. The filtrate of the combined aliquots was analysed using HPLC.

The yield for the solid residue was 0.035 g. Ultimate analysis of the solid residues produced the following results: 52.5% carbon, 5.7% hydrogen, 0.5% nitrogen, 0.5% sulphur and 40.8% oxygen (by difference). In the aqueous solution, the yields were as follows: cellobiose 6.0%, glucose 3.8% and xylose 7.2%. The yields of glucose and cellobiose were with respect to the hexose fraction in the original biomass. Similarly, the yield of xylose was with respect to the pentose fraction in the original biomass.

### Example 3

Beechwood shavings were processed to a powder using a kitchen mixer. The powder was sieved and the particles under 250 μm were used as described below.

Beechwood shavings (10 g) were dispersed in diethyl ether (150 mL) and sulphuric acid (0.52 mL, 95-97%, a commercially available product from J T Baker, USA) was added dropwise. The suspension was stirred for 1 hour before the solvent was removed under reduced pressure. Further, the powder which had been impregnated with acid and dried (1 g) was milled for 2 hours in a steel bowl with steel balls (5 steel balls; individual weight 3.95 g) in a Pulverisette P7 from Fritsch. The rotational speed of the main disk was 800 rpm. A sample of the powder obtained was dissolved in water and examined using HPLC analysis. The powder obtained was completely water-soluble and produced a clear reddish-brown solution.

The powder obtained (0.9 g with acid) was dissolved in water (9 mL). The solution was heated for 1 hour to 70° C. The solid obtained thereby (lignin) was separated by filtration or centrifuging.

The solid was washed 6 times with 25 mL of water each time. The solid was then dried for 24 hours under vacuum at 60° C. The dry solid was weighed. The chemical composition of the solid was investigated by means of elemental analysis and infrared spectroscopy. The filtrate of the combined aliquots was analysed using HPLC.

The yield for the solid residue was 0.093 g. Ultimate analysis of the solid residues produced the following results: 55.0% carbon, 5.4% hydrogen, 0.5% nitrogen, 0.5% sulphur and 38.5% oxygen (by difference). In the aqueous solution, the yields were as follows: cellobiose 6.1%, glucose 4.3% and xylose 9.2%. The yields of glucose and cellobiose were with respect to the hexose fraction in the original biomass. Similarly, the yield of xylose was with respect to the pentose fraction in the original biomass.

### Example 4

Beechwood shavings were processed to a powder using a kitchen mixer. The powder was sieved and the particles under 250 μm were used as described below.

Beechwood shavings (10 g) were dispersed in diethyl ether (150 mL) and sulphuric acid (0.52 mL, 95-97%, a commercially available product from J T Baker, USA) was added dropwise. The suspension was stirred for 1 hour before the solvent was removed under reduced pressure. Further, the powder which had been impregnated with acid and dried (1 g) was milled for 2 hours in a steel bowl with steel balls (5 steel balls; individual weight 3.95 g) in a Pulverisette P7 from Fritsch. The rotational speed of the main disk was 800 rpm. A sample of the powder obtained was dissolved in water and examined using HPLC analysis. The powder obtained was completely water-soluble and produced a clear reddish-brown solution.

The powder obtained (0.9 g with acid) was dissolved in water (9 mL). The solution was heated for 1 hour to 80° C. The solid obtained thereby (lignin) was separated by filtration or centrifuging.

The solid was washed 6 times with 25 mL of water each time. The solid was then dried for 24 hours under vacuum at 60° C. The dry solid was weighed. The chemical composition of the solid was investigated by means of elemental analysis and infrared spectroscopy. The filtrate of the combined aliquots was analysed using HPLC.

The yield for the solid residue was 0.163 g. Ultimate analysis of the solid residues produced the following results: 56.3% carbon, 5.8% hydrogen, 0.4% nitrogen, 0.0% sulphur and 37.5% oxygen (by difference). In the aqueous solution, the yields were as follows: cellobiose 6.1%, glucose 4.8% and xylose 10.8%. The yields of glucose and cellobiose were with respect to the hexose fraction in the original biomass. Similarly, the yield of xylose was with respect to the pentose fraction in the original biomass.

### Example 5

Beechwood shavings were processed to a powder using a kitchen mixer. The powder was sieved and the particles under 250 μm were used as described below.

Beechwood shavings (10 g) were dispersed in diethyl ether (150 mL) and sulphuric acid (0.52 mL, 95-97%, a commercially available product from J T Baker, USA) was added dropwise. The suspension was stirred for 1 hour before the solvent was removed under reduced pressure. Further, the powder which had been impregnated with acid and dried (1 g) was milled for 2 hours in a steel bowl with steel balls (5 steel balls; individual weight 3.95 g) in a Pulverisette P7 from Fritsch. The rotational speed of the main disk was 800 rpm. A sample of the powder obtained was dissolved in water and examined using HPLC analysis. The powder obtained was completely water-soluble and produced a clear reddish-brown solution.

The powder obtained (0.9 g with acid) was dissolved in water (9 mL). The solution was heated for 1 hour to 90° C. The solid obtained thereby (lignin) was separated by filtration or centrifuging.

The solid was washed 6 times with 25 mL of water each time. The solid was then dried for 24 hours under vacuum at 60° C. The dry solid was weighed. The chemical composition of the solid was investigated by means of elemental analysis and infrared spectroscopy. The filtrate of the combined aliquots was analysed using HPLC.

The yield for the solid residue was 0.220 g. Ultimate analysis of the solid residues produced the following results: 57.4% carbon, 5.8% hydrogen, 0.5% nitrogen, 0.5% sulphur and 35.7% oxygen (by difference). In the aqueous solution, the yields were as follows: cellobiose 6.6%, glucose 5.9% and xylose 15.6%. The yields of glucose and cellobiose were with respect to the hexose fraction in the original biomass. Similarly, the yield of xylose was with respect to the pentose fraction in the original biomass.

### Example 6

Beechwood shavings were processed to a powder using a kitchen mixer. The powder was sieved and the particles under 250 μm were used as described below.

Beechwood shavings (10 g) were dispersed in diethyl ether (150 mL) and sulphuric acid (0.52 mL, 95-97%, a commercially available product from J T Baker, USA) was added dropwise. The suspension was stirred for 1 hour before the solvent was removed under reduced pressure. Further, the powder which had been impregnated with acid and dried (1 g) was milled for 2 hours in a steel bowl with steel balls (5 steel balls; individual weight 3.95 g) in a Pulverisette P7 from Fritsch. The rotational speed of the main disk was 800 rpm. A sample of the powder obtained was dissolved in water and examined using HPLC analysis. The powder obtained was completely water-soluble and produced a clear reddish-brown solution.

The powder obtained (0.9 g with acid) was dissolved in water (9 mL). The solution was heated for 1 hour to 100° C. The solid obtained thereby (lignin) was separated by filtration or centrifuging.

The solid was washed 6 times with 25 mL of water each time. The solid was then dried for 24 hours under vacuum at 60° C. The dry solid was weighed. The chemical composition of the solid was investigated by means of elemental analysis and infrared spectroscopy. The filtrate of the combined aliquots was analysed using HPLC.

The yield for the solid residue was 0.221 g. Ultimate analysis of the solid residues produced the following results: 58.2% carbon, 5.9% hydrogen, 0.4% nitrogen, 0.4% sulphur and 35.1% oxygen (by difference). In the aqueous solution, the yields were as follows: cellobiose 7.9%, glucose 8.7% and xylose 25.4%. The yields of glucose and cellobiose were with respect to the hexose fraction in the original biomass. Similarly, the yield of xylose was with respect to the pentose fraction in the original biomass.

### Example 7

Beechwood shavings were processed to a powder using a kitchen mixer. The powder was sieved and the particles under 250 μm were used as described below.

Beechwood shavings (10 g) were dispersed in diethyl ether (150 mL) and sulphuric acid (0.52 mL, 95-97%, a commercially available product from J T Baker, USA) was added dropwise. The suspension was stirred for 1 hour before the solvent was removed under reduced pressure. Further, the powder which had been impregnated with acid and dried (1 g) was milled for 2 hours in a steel bowl with steel balls (5 steel balls; individual weight 3.95 g) in a Pulverisette P7 from Fritsch. The rotational speed of the main disk was 800 rpm. A sample of the powder obtained was dissolved in water and examined using HPLC analysis. The powder obtained was completely water-soluble and produced a clear reddish-brown solution.

The powder obtained (0.9 g with acid) was dissolved in water (9 mL). The solution was heated for 1 hour to 110° C. The solid obtained thereby (lignin) was separated by filtration or centrifuging.

The solid was washed 6 times with 25 mL of water each time. The solid was then dried for 24 hours under vacuum at 60° C. The dry solid was weighed. The chemical composition of the solid was investigated by means of elemental analysis and infrared spectroscopy. The filtrate of the combined aliquots was analysed using HPLC.

The yield for the solid residue was 0.217 g. Ultimate analysis of the solid residues produced the following results: 58.7% carbon, 6.0% hydrogen, 0.5% nitrogen, 0.4% sulphur and 34.4% oxygen (by difference). In the aqueous solution, the yields were as follows: cellobiose 10.7%, glucose 15.4% and xylose 51.4%. The yields of glucose and cellobiose were with respect to the hexose fraction in the original biomass. Similarly, the yield of xylose was with respect to the pentose fraction in the original biomass.

### Example 8

Beechwood shavings were processed to a powder using a kitchen mixer. The powder was sieved and the particles under 250 μm were used as described below.

Beechwood shavings (10 g) were dispersed in diethyl ether (150 mL) and sulphuric acid (0.52 mL, 95-97%, a commercially available product from J T Baker, USA) was added dropwise. The suspension was stirred for 1 hour before the solvent was removed under reduced pressure. Further, the powder which had been impregnated with acid and dried (1 g) was milled for 2 hours in a steel bowl with steel balls (5 steel balls; individual weight 3.95 g) in a Pulverisette P7 from Fritsch. The rotational speed of the main disk was 800 rpm. A sample of the powder obtained was dissolved in water and examined using HPLC analysis. The powder obtained was completely water-soluble and produced a clear reddish-brown solution.

The powder obtained (0.9 g with acid) was dissolved in water (9 mL). The solution was heated for 1 hour to 120° C. The solid obtained thereby (lignin) was separated by filtration or centrifuging.

The solid was washed 6 times with 25 mL of water each time. The solid was then dried for 24 hours under vacuum at 60° C. The dry solid was weighed. The chemical composition of the solid was investigated by means of elemental analysis and infrared spectroscopy. The filtrate of the combined aliquots was analysed using HPLC.

The yield for the solid residue was 0.203 g. Ultimate analysis of the solid residues produced the following results: 59.2% carbon, 5.8% hydrogen, 0.5% nitrogen, 0.4% sulphur and 33.9% oxygen (by difference). In the aqueous solution, the yields were as follows: cellobiose 17.4%, glucose 34.4% and xylose 87.6%. The yields of glucose and cellobiose were with respect to the hexose fraction in the original biomass. Similarly, the yield of xylose was with respect to the pentose fraction in the original biomass.

### Example 9

Beechwood shavings were processed to a powder using a kitchen mixer. The powder was sieved and the particles under 250 μm were used as described below.

Beechwood shavings (10 g) were dispersed in diethyl ether (150 mL) and sulphuric acid (0.52 mL, 95-97%, a commercially available product from J T Baker, USA) was added dropwise. The suspension was stirred for 1 hour before the solvent was removed under reduced pressure. Further, the powder which had been impregnated with acid and dried (1 g) was milled for 2 hours in a steel bowl with steel balls (5 steel balls; individual weight 3.95 g) in a Pulverisette P7 from Fritsch. The rotational speed of the main disk was 800 rpm. A sample of the powder obtained was dissolved in water and examined using HPLC analysis. The powder obtained was completely water-soluble and produced a clear reddish-brown solution.

The powder obtained (0.9 g with acid) was dissolved in water (9 mL). The solution was heated for 1 hour to 130° C. The solid obtained thereby (lignin) was separated by filtration or centrifuging.

The solid was washed 6 times with 25 mL of water each time. The solid was then dried for 24 hours under vacuum at 60° C. The dry solid was weighed. The chemical composition of the solid was investigated by means of elemental analysis and infrared spectroscopy. The filtrate of the combined aliquots was analysed using HPLC.

The yield for the solid residue was 0.197 g. Ultimate analysis of the solid residues produced the following results: 60.6% carbon, 5.8% hydrogen, 0.2% nitrogen, 0.0% sulphur and 33.4% oxygen (by difference). In the aqueous solution, the yields were as follows: cellobiose 12.8%, glucose 69.2% and xylose 91.8%. The yields of glucose and cellobiose were with respect to the hexose fraction in the original biomass. Similarly, the yield of xylose was with respect to the pentose fraction in the original biomass.

### Example 10

Beechwood shavings were processed to a powder using a kitchen mixer. The powder was sieved and the particles under 250 μm were used as described below.

Beechwood shavings (10 g) were dispersed in diethyl ether (150 mL) and sulphuric acid (0.52 mL, 95-97%, a commercially available product from J T Baker, USA) was added dropwise. The suspension was stirred for 1 hour before the solvent was removed under reduced pressure. Further, the powder which had been impregnated with acid and dried (1 g) was milled for 2 hours in a steel bowl with steel balls (5 steel balls; individual weight 3.95 g) in a Pulverisette P7 from Fritsch. The rotational speed of the main disk was 800 rpm. A sample of the powder obtained was dissolved in water and examined using HPLC analysis. The powder obtained was completely water-soluble and produced a clear reddish-brown solution.

The powder obtained (0.9 g with acid) was dissolved in water (9 mL). The solution was heated for 1 hour to 135° C. The solid obtained thereby (lignin) was separated by filtration or centrifuging.

The solid was washed 6 times with 25 mL of water each time. The solid was then dried for 24 hours under vacuum at 60° C. The dry solid was weighed. The chemical composition of the solid was investigated by means of elemental analysis and infrared spectroscopy. The filtrate of the combined aliquots was analysed using HPLC.

The yield for the solid residue was 0.183 g. Ultimate analysis of the solid residues produced the following results: 61.4% carbon, 5.6% hydrogen, 0.3% nitrogen, 0.1% sulphur and 32.7% oxygen (by difference). In the aqueous solution, the yields were as follows: cellobiose 8.6%, glucose 83.2% and xylose 93.7%. The yields of glucose and cellobiose were with respect to the hexose fraction in the original biomass. Similarly, the yield of xylose was with respect to the pentose fraction in the original biomass.

### Example 11

Beechwood shavings were processed to a powder using a kitchen mixer. The powder was sieved and the particles under 250 μm were used as described below.

Beechwood shavings (10 g) were dispersed in diethyl ether (150 mL) and sulphuric acid (0.52 mL, 95-97%, a commercially available product from J T Baker, USA) was added dropwise. The suspension was stirred for 1 hour before the solvent was removed under reduced pressure. Further, the powder which had been impregnated with acid and dried (1 g) was milled for 2 hours in a steel bowl with steel balls (5 steel balls; individual weight 3.95 g) in a Pulverisette P7 from Fritsch. The rotational speed of the main disk was 800 rpm. A sample of the powder obtained was dissolved in water and examined using HPLC analysis. The powder obtained was completely water-soluble and produced a clear reddish-brown solution.

The powder obtained (0.9 g with acid) was dissolved in water (9 mL). The solution was heated for 1 hour to 140° C. The solid obtained thereby (lignin) was separated by filtration or centrifuging.

The solid was washed 6 times with 25 mL of water each time. The solid was then dried for 24 hours under vacuum at 60° C. The dry solid was weighed. The chemical composition of the solid was investigated by means of elemental analysis and infrared spectroscopy. The filtrate of the combined aliquots was analysed using HPLC.

The yield for the solid residue was 0.190 g. Ultimate analysis of the solid residues produced the following results: 60.6% carbon, 5.5% hydrogen, 0.2% nitrogen, 0.0% sulphur and 33.7% oxygen (by difference). In the aqueous solution, the yields were as follows: cellobiose 3.5%, glucose 88.3% and xylose 92.5%. The yields of glucose and cellobiose were with respect to the hexose fraction in the original biomass. Similarly, the yield of xylose was with respect to the pentose fraction in the original biomass.

### Example 12

Beechwood shavings were processed to a powder using a kitchen mixer. The powder was sieved and the particles under 250 μm were used as described below.

Beechwood shavings (10 g) were dispersed in diethyl ether (150 mL) and sulphuric acid (0.52 mL, 95-97%, a commercially available product from J T Baker, USA) was added dropwise. The suspension was stirred for 1 hour before the solvent was removed under reduced pressure. Further, the powder which had been impregnated with acid and dried (1 g) was milled for 2 hours in a steel bowl with steel balls (5 steel balls; individual weight 3.95 g) in a Pulverisette P7 from Fritsch. The rotational speed of the main disk was 800 rpm. A sample of the powder obtained was dissolved in water and examined using HPLC analysis. The powder obtained was completely water-soluble and produced a clear reddish-brown solution.

The powder obtained (0.9 g with acid) was dissolved in water (9 mL). The solution was heated for 1 hour to 145° C. The solid obtained thereby (lignin) was separated by filtration or centrifuging.

The solid was washed 6 times with 25 mL of water each time. The solid was then dried for 24 hours under vacuum at 60° C. The dry solid was weighed. The chemical composition of the solid was investigated by means of elemental analysis and infrared spectroscopy. The filtrate of the combined aliquots was analysed using HPLC.

The yield for the solid residue was 0.187 g. Ultimate analysis of the solid residues produced the following results: 61.3% carbon, 5.7% hydrogen, 0.1% nitrogen, 0.0% sulphur and 32.9% oxygen (by difference). In the aqueous solution, the yields were as follows: cellobiose 3.2%, glucose 91.2% and xylose 92.2%. The yields of glucose and cellobiose were with respect to the hexose fraction in the original biomass. Similarly, the yield of xylose was with respect to the pentose fraction in the original biomass.

### Example 13

Sugarcane bagasse was processed to a powder using a kitchen mixer. The powder was sieved and the particles under 250 μm were used as described below.

The classified sugarcane bagasse (10 g) was dispersed in diethyl ether (150 mL) and sulphuric acid (0.52 mL, 95-97%, a commercially available product from J T Baker, USA) was added dropwise. The suspension was stirred for 1 hour before the solvent was removed under reduced pressure. Further, the powder which had been impregnated with acid and dried (1 g) was milled for 3 hours in a steel bowl with steel balls (5 steel balls; individual weight 3.95 g) in a Pulverisette P7 from Fritsch. The rotational speed of the main disk was 800 rpm. A sample of the powder obtained was dissolved in water and examined using HPLC analysis. The powder obtained was completely water-soluble and produced a clear reddish-brown solution.

The powder obtained (0.9 g with acid) was dissolved in water (4.5 mL). The solution was heated for 1 hour to 60° C. The solid obtained thereby (lignin) was separated by filtration or centrifuging.

The solid was washed 6 times with 25 mL of water each time. The solid was then dried for 24 hours under vacuum at 60° C. The dry solid was weighed. The chemical composition of the solid was investigated by means of elemental analysis and infrared spectroscopy. The filtrate of the combined aliquots was analysed using HPLC.

The yield for the solid residue was 0.190 g. Ultimate analysis of the solid residues produced the following results: 46.0% carbon, 6.2% hydrogen, 0.3% nitrogen, 0.2% sulphur and 47.4% oxygen (by difference). In the aqueous solution, the yields were as follows: cellobiose 5.1%, glucose 4.0% and xylose 13.3%. The yields of glucose and cellobiose were with respect to the hexose fraction in the original biomass. Similarly, the yield of xylose was with respect to the pentose fraction in the original biomass.

### Example 14

Sugarcane bagasse was processed to a powder using a kitchen mixer. The powder was sieved and the particles under 250 μm were used as described below.

The classified sugarcane bagasse (10 g) was dispersed in diethyl ether (150 mL) and sulphuric acid (0.52 mL, 95-97%, a commercially available product from J T Baker, USA) was added dropwise. The suspension was stirred for 1 hour before the solvent was removed under reduced pressure. Further, the powder which had been impregnated with acid and dried (1 g) was milled for 3 hours in a steel bowl with steel balls (5 steel balls; individual weight 3.95 g) in a Pulverisette P7 from Fritsch. The rotational speed of the main disk was 800 rpm. A sample of the powder obtained was dissolved in water and examined using HPLC analysis. The powder obtained was completely water-soluble and produced a clear reddish-brown solution.

The powder obtained (0.9 g with acid) was dissolved in water (6.75 mL). The solution was heated for 1 hour to 60° C. The solid obtained thereby (lignin) was separated by filtration or centrifuging.

The solid was washed 6 times with 25 mL of water each time. The solid was then dried for 24 hours under vacuum at 60° C. The dry solid was weighed. The chemical composition of the solid was investigated by means of elemental analysis and infrared spectroscopy. The filtrate of the combined aliquots was analysed using HPLC.

The yield for the solid residue was 0.153 g. Ultimate analysis of the solid residues produced the following results: 46.6% carbon, 6.2% hydrogen, 0.3% nitrogen, 0.2% sulphur and 46.7% oxygen (by difference). In the aqueous solution, the yields were as follows: cellobiose 4.5%, glucose 3.7% and xylose 12.7%. The yields of glucose and cellobiose were with respect to the hexose fraction in the original biomass. Similarly, the yield of xylose was with respect to the pentose fraction in the original biomass.

### Example 15

Sugarcane bagasse was processed to a powder using a kitchen mixer. The powder was sieved and the particles under 250 μm were used as described below.

The classified sugarcane bagasse (10 g) was dispersed in diethyl ether (150 mL) and sulphuric acid (0.52 mL, 95-97%, a commercially available product from J T Baker, USA) was added dropwise. The suspension was stirred for 1 hour before the solvent was removed under reduced pressure. Further, the powder which had been impregnated with acid and dried (1 g) was milled for 3 hours in a steel bowl with steel balls (5 steel balls; individual weight 3.95 g) in a Pulverisette P7 from Fritsch. The rotational speed of the main disk was 800 rpm. A sample of the powder obtained was dissolved in water and examined using HPLC analysis. The powder obtained was completely water-soluble and produced a clear reddish-brown solution.

The powder obtained (0.9 g with acid) was dissolved in water (9 mL). The solution was heated for 1 hour to 60° C. The solid obtained thereby (lignin) was separated by filtration or centrifuging.

The solid was washed 6 times with 25 mL of water each time. The solid was then dried for 24 hours under vacuum at 60° C. The dry solid was weighed. The chemical composition of the solid was investigated by means of elemental analysis and infrared spectroscopy. The filtrate of the combined aliquots was analysed using HPLC.

The yield for the solid residue was 0.173 g. Ultimate analysis of the solid residues produced the following results: 48.0% carbon, 6.3% hydrogen, 0.4% nitrogen, 0.3% sulphur and 44.9% oxygen (by difference). In the aqueous solution, the yields were as follows: cellobiose 5.3%, glucose 3.7% and xylose 12.9%. The yields of glucose and cellobiose were with respect to the hexose fraction in the original biomass. Similarly, the yield of xylose was with respect to the pentose fraction in the original biomass.

### Example 16

Sugarcane bagasse was processed to a powder using a kitchen mixer. The powder was sieved and the particles under 250 μm were used as described below.

The classified sugarcane bagasse (10 g) was dispersed in diethyl ether (150 mL) and sulphuric acid (0.52 mL, 95-97%, a commercially available product from J T Baker, USA) was added dropwise. The suspension was stirred for 1 hour before the solvent was removed under reduced pressure. Further, the powder which had been impregnated with acid and dried (1 g) was milled for 3 hours in a steel bowl with steel balls (5 steel balls; individual weight 3.95 g) in a Pulverisette P7 from Fritsch. The rotational speed of the main disk was 800 rpm. A sample of the powder obtained was dissolved in water and examined using HPLC analysis. The powder obtained was completely water-soluble and produced a clear reddish-brown solution.

The powder obtained (0.9 g with acid) was dissolved in water (9 mL). The solution was heated for 1 hour to 70° C. The solid obtained thereby (lignin) was separated by filtration or centrifuging.

The solid was washed 6 times with 25 mL of water each time. The solid was then dried for 24 hours under vacuum at 60° C. The dry solid was weighed. The chemical composition of the solid was investigated by means of elemental analysis and infrared spectroscopy. The filtrate of the combined aliquots was analysed using HPLC.

The yield for the solid residue was 0.198 g. Ultimate analysis of the solid residues produced the following results: 50.9% carbon, 5.8% hydrogen, 0.5% nitrogen, 0.4% sulphur and 42.4% oxygen (by difference). In the aqueous solution, the yields were as follows: cellobiose 5.3%, glucose 4.1% and xylose 12.7%. The yields of glucose and cellobiose were with respect to the hexose fraction in the original biomass. Similarly, the yield of xylose was with respect to the pentose fraction in the original biomass.

### Example 17

Sugarcane bagasse was processed to a powder using a kitchen mixer. The powder was sieved and the particles under 250 μm were used as described below.

The classified sugarcane bagasse (10 g) was dispersed in diethyl ether (150 mL) and sulphuric acid (0.52 mL, 95-97%, a commercially available product from J T Baker, USA) was added dropwise. The suspension was stirred for 1 hour before the solvent was removed under reduced pressure. Further, the powder which had been impregnated with acid and dried (1 g) was milled for 3 hours in a steel bowl with steel balls (5 steel balls; individual weight 3.95 g) in a Pulverisette P7 from Fritsch. The rotational speed of the main disk was 800 rpm. A sample of the powder obtained was dissolved in water and examined using HPLC analysis. The powder obtained was completely water-soluble and produced a clear reddish-brown solution.

The powder obtained (0.9 g with acid) was dissolved in water (9 mL). The solution was heated for 1 hour to 80° C. The solid obtained thereby (lignin) was separated by filtration or centrifuging.

The solid was washed 6 times with 25 mL of water each time. The solid was then dried for 24 hours under vacuum at 60° C. The dry solid was weighed. The chemical composition of the solid was investigated by means of elemental analysis and infrared spectroscopy. The filtrate of the combined aliquots was analysed using HPLC.

The yield for the solid residue was 0.216 g. Ultimate analysis of the solid residues produced the following results: 51.3% carbon, 5.6% hydrogen, 0.3% nitrogen, 0.4% sulphur and 42.4% oxygen (by difference). In the aqueous solution, the yields were as follows: cellobiose 6.4%, glucose 5.1% and xylose 15.6%. The yields of glucose and cellobiose were with respect to the hexose fraction in the original biomass. Similarly, the yield of xylose was with respect to the pentose fraction in the original biomass.

### Example 18

Sugarcane bagasse was processed to a powder using a kitchen mixer. The powder was sieved and the particles under 250 μm were used as described below.

The classified sugarcane bagasse (10 g) was dispersed in diethyl ether (150 mL) and sulphuric acid (0.52 mL, 95-97%, a commercially available product from J T Baker, USA) was added dropwise. The suspension was stirred for 1 hour before the solvent was removed under reduced pressure. Further, the powder which had been impregnated with acid and dried (1 g) was milled for 3 hours in a steel bowl with steel balls (5 steel balls; individual weight 3.95 g) in a Pulverisette P7 from Fritsch. The rotational speed of the main disk was 800 rpm. A sample of the powder obtained was dissolved in water and examined using HPLC analysis. The powder obtained was completely water-soluble and produced a clear reddish-brown solution.

The powder obtained (0.9 g with acid) was dissolved in water (9 mL). The solution was heated for 1 hour to 90° C. The solid obtained thereby (lignin) was separated by filtration or centrifuging.

The solid was washed 6 times with 25 mL of water each time. The solid was then dried for 24 hours under vacuum at 60° C. The dry solid was weighed. The chemical composition of the solid was investigated by means of elemental analysis and infrared spectroscopy. The filtrate of the combined aliquots was analysed using HPLC.

The yield for the solid residue was 0.250 g. Ultimate analysis of the solid residues produced the following results: 52.0% carbon, 5.9% hydrogen, 0.4% nitrogen, 0.4% sulphur and 41.3% oxygen (by difference). In the aqueous solution, the yields were as follows: cellobiose 5.5%, glucose 5.0% and xylose 20.4%.

### Example 19

Sugarcane bagasse was processed to a powder using a kitchen mixer. The powder was sieved and the particles under 250 μm were used as described below.

The classified sugarcane bagasse (10 g) was dispersed in diethyl ether (150 mL) and sulphuric acid (0.52 mL, 95-97%, a commercially available product from J T Baker, USA) was added dropwise. The suspension was stirred for 1 hour before the solvent was removed under reduced pressure. Further, the powder which had been impregnated with acid and dried (1 g) was milled for 3 hours in a steel bowl with steel balls (5 steel balls; individual weight 3.95 g) in a Pulverisette P7 from Fritsch. The rotational speed of the main disk was 800 rpm. A sample of the powder obtained was dissolved in water and examined using HPLC analysis. The powder obtained was completely water-soluble and produced a clear reddish-brown solution.

The powder obtained (0.9 g with acid) was dissolved in water (9 mL). The solution was heated for 1 hour to 100° C. The solid obtained thereby (lignin) was separated by filtration or centrifuging.

The solid was washed 6 times with 25 mL of water each time. The solid was then dried for 24 hours under vacuum at 60° C. The dry solid was weighed. The chemical composition of the solid was investigated by means of elemental analysis and infrared spectroscopy. The filtrate of the combined aliquots was analysed using HPLC.

The yield for the solid residue was 0.242 g. Ultimate analysis of the solid residues produced the following results: 52.4% carbon, 5.9% hydrogen, 0.5% nitrogen, 0.1% sulphur and 4.1% oxygen (by difference). In the aqueous solution, the yields were as follows: cellobiose 7.4%, glucose 7.7% and xylose 32.6%. The yields of glucose and cellobiose were with respect to the hexose fraction in the original biomass. Similarly, the yield of xylose was with respect to the pentose fraction in the original biomass.

### Example 20

Sugarcane bagasse was processed to a powder using a kitchen mixer. The powder was sieved and the particles under 250 μm were used as described below.

The classified sugarcane bagasse (10 g) was dispersed in diethyl ether (150 mL) and sulphuric acid (0.52 mL, 95-97%, a commercially available product from J T Baker, USA) was added dropwise. The suspension was stirred for 1 hour before the solvent was removed under reduced pressure. Further, the powder which had been impregnated with acid and dried (1 g) was milled for 3 hours in a steel bowl with steel balls (5 steel balls; individual weight 3.95 g) in a Pulverisette P7 from Fritsch. The rotational speed of the main disk was 800 rpm. A sample of the powder obtained was dissolved in water and examined using HPLC analysis. The powder obtained was completely water-soluble and produced a clear reddish-brown solution.

The powder obtained (0.9 g with acid) was dissolved in water (9 mL). The solution was heated for 1 hour to 110° C. The solid obtained thereby (lignin) was separated by filtration or centrifuging.

The solid was washed 6 times with 25 mL of water each time. The solid was then dried for 24 hours under vacuum at 60° C. The dry solid was weighed. The chemical composition of the solid was investigated by means of elemental analysis and infrared spectroscopy. The filtrate of the combined aliquots was analysed using HPLC.

The yield for the solid residue was 0.229 g. Ultimate analysis of the solid residues produced the following results: 52.9% carbon, 6.0% hydrogen, 0.3% nitrogen, 0.3% sulphur and 40.7% oxygen (by difference). In the aqueous solution, the yields were as follows: cellobiose 10.1%, glucose 15.3% and xylose 75.4%. The yields of glucose and cellobiose were with respect to the hexose fraction in the original biomass. Similarly, the yield of xylose was with respect to the pentose fraction in the original biomass.

### Example 21

Sugarcane bagasse was processed to a powder using a kitchen mixer. The powder was sieved and the particles under 250 μm were used as described below.

The classified sugarcane bagasse (10 g) was dispersed in diethyl ether (150 mL) and sulphuric acid (0.52 mL, 95-97%, a commercially available product from J T Baker, USA) was added dropwise. The suspension was stirred for 1 hour before the solvent was removed under reduced pressure. Further, the powder which had been impregnated with acid and dried (1 g) was milled for 3 hours in a steel bowl with steel balls (5 steel balls; individual weight 3.95 g) in a Pulverisette P7 from Fritsch. The rotational speed of the main disk was 800 rpm. A sample of the powder obtained was dissolved in water and examined using HPLC analysis. The powder obtained was completely water-soluble and produced a clear reddish-brown solution.

The powder obtained (0.9 g with acid) was dissolved in water (9 mL). The solution was heated for 1 hour to 120° C. The solid obtained thereby (lignin) was separated by filtration or centrifuging.

The solid was washed 6 times with 25 mL of water each time. The solid was then dried for 24 hours under vacuum at 60° C. The dry solid was weighed. The chemical composition of the solid was investigated by means of elemental analysis and infrared spectroscopy. The filtrate of the combined aliquots was analysed using HPLC.

The yield for the solid residue was 0.188 g. Ultimate analysis of the solid residues produced the following results: 53.3% carbon, 6.3% hydrogen, 0.4% nitrogen, 0.2% sulphur and 39.9% oxygen (by difference). In the aqueous solution, the yields were as follows: cellobiose 18.6%, glucose 35.4% and xylose 100%. The yields of glucose and cellobiose were with respect to the hexose fraction in the original biomass. Similarly, the yield of xylose was with respect to the pentose fraction in the original biomass.

### Example 22

Sugarcane bagasse was processed to a powder using a kitchen mixer. The powder was sieved and the particles under 250 μm were used as described below.

The classified sugarcane bagasse (10 g) was dispersed in diethyl ether (150 mL) and sulphuric acid (0.52 mL, 95-97%, a commercially available product from J T Baker, USA) was added dropwise. The suspension was stirred for 1 hour before the solvent was removed under reduced pressure. Further, the powder which had been impregnated with acid and dried (1 g) was milled for 3 hours in a steel bowl with steel balls (5 steel balls; individual weight 3.95 g) in a Pulverisette P7 from Fritsch. The rotational speed of the main disk was 800 rpm. A sample of the powder obtained was dissolved in water and examined using HPLC analysis. The powder obtained was completely water-soluble and produced a clear reddish-brown solution.

The powder obtained (0.9 g with acid) was dissolved in water (9 mL). The solution was heated for 1 hour to 130° C. The solid obtained thereby (lignin) was separated by filtration or centrifuging.

The solid was washed 6 times with 25 mL of water each time. The solid was then dried for 24 hours under vacuum at 60° C. The dry solid was weighed. The chemical composition of the solid was investigated by means of elemental analysis and infrared spectroscopy. The filtrate of the combined aliquots was analysed using HPLC.

The yield for the solid residue was 0.149 g. Ultimate analysis of the solid residues produced the following results: 56.3% carbon, 6.0% hydrogen, 0.3% nitrogen, 0.1% sulphur and 37.4% oxygen (by difference). In the aqueous solution, the yields were as follows: cellobiose 15.8%, glucose 65.6% and xylose 95.4%. The yields of glucose and cellobiose were with respect to the hexose fraction in the original biomass. Similarly, the yield of xylose was with respect to the pentose fraction in the original biomass.

### Example 23

Sugarcane bagasse was processed to a powder using a kitchen mixer. The powder was sieved and the particles under 250 μm were used as described below.

The classified sugarcane bagasse (10 g) was dispersed in diethyl ether (150 mL) and sulphuric acid (0.52 mL, 95-97%, a commercially available product from J T Baker, USA) was added dropwise. The suspension was stirred for 1 hour before the solvent was removed under reduced pressure. Further, the powder which had been impregnated with acid and dried (1 g) was milled for 3 hours in a steel bowl with steel balls (5 steel balls; individual weight 3.95 g) in a Pulverisette P7 from Fritsch. The rotational speed of the main disk was 800 rpm. A sample of the powder obtained was dissolved in water and examined using HPLC analysis. The powder obtained was completely water-soluble and produced a clear reddish-brown solution.

The powder obtained (0.9 g with acid) was dissolved in water (9 mL). The solution was heated for 1 hour to 140° C. The solid obtained thereby (lignin) was separated by filtration or centrifuging.

The solid was washed 6 times with 25 mL of water each time. The solid was then dried for 24 hours under vacuum at 60° C. The dry solid was weighed. The chemical composition of the solid was investigated by means of elemental analysis and infrared spectroscopy. The filtrate of the combined aliquots was analysed using HPLC.

The yield for the solid residue was 0.142 g. Ultimate analysis of the solid residues produced the following results: 59.4% carbon, 6.0% hydrogen, 0.4% nitrogen, 0.2% sulphur and 33.9% oxygen (by difference). In the aqueous solution, the yields were as follows: cellobiose 8.8%, glucose 92.0% and xylose 94.8%. The yields of glucose and cellobiose were with respect to the hexose fraction in the original biomass. Similarly, the yield of xylose was with respect to the pentose fraction in the original biomass.

### Example 24

Sugarcane bagasse was processed to a powder using a kitchen mixer. The powder was sieved and the particles under 250 μm were used as described below.

The classified sugarcane bagasse (10 g) was dispersed in diethyl ether (150 mL) and sulphuric acid (0.52 mL, 95-97%, a commercially available product from J T Baker, USA) was added dropwise. The suspension was stirred for 1 hour before the solvent was removed under reduced pressure. Further, the powder which had been impregnated with acid and dried (1 g) was milled for 3 hours in a steel bowl with steel balls (5 steel balls; individual weight 3.95 g) in a Pulverisette P7 from Fritsch. The rotational speed of the main disk was 800 rpm. A sample of the powder obtained was dissolved in water and examined using HPLC analysis. The powder obtained was completely water-soluble and produced a clear reddish-brown solution.

The powder obtained (0.9 g with acid) was dissolved in water (9 mL). The solution was heated for 1 hour to 145° C. The solid obtained thereby (lignin) was separated by filtration or centrifuging.

The solid was washed 6 times with 25 mL of water each time. The solid was then dried for 24 hours under vacuum at 60° C. The dry solid was weighed. The chemical composition of the solid was investigated by means of elemental analysis and infrared spectroscopy. The filtrate of the combined aliquots was analysed using HPLC.

The yield for the solid residue was 0.163 g. Ultimate analysis of the solid residues produced the following results: 56.6% carbon, 5.6% hydrogen, 0.3% nitrogen, 0.0% sulphur and 37.5% oxygen (by difference). In the aqueous solution, the yields were as follows: cellobiose 1.7%, glucose 87.4% and xylose 89.6%. The yields of glucose and cellobiose were with respect to the hexose fraction in the original biomass. Similarly, the yield of xylose was with respect to the pentose fraction in the original biomass.

### Example 25

Pinewood shavings were processed to a powder using a kitchen mixer. The powder was sieved and the particles under 250 μm were used as described below.

Pinewood shavings (10 g) were dispersed in diethyl ether (150 mL) and sulphuric acid (0.52 mL, 95-97%, a commercially available product from J T Baker, USA) was added dropwise. The suspension was stirred for 1 hour before the solvent was removed under reduced pressure. Further, the powder which had been impregnated with acid and dried (1 g) was milled for 3 hours in a steel bowl with steel balls (5 steel balls; individual weight 3.95 g) in a Pulverisette P7 from Fritsch. The rotational speed of the main disk was 800 rpm. A sample of the powder obtained was dissolved in water and examined using HPLC analysis. The powder obtained was completely water-soluble and produced a clear reddish-brown solution.

The powder obtained (0.9 g with acid) was dissolved in water (4.5 mL). The solution was heated for 1 hour to 60° C. The solid obtained thereby (lignin) was separated by filtration or centrifuging.

The solid was washed 6 times with 25 mL of water each time. The solid was then dried for 24 hours under vacuum at 60° C. The dry solid was weighed. The chemical composition of the solid was investigated by means of elemental analysis and infrared spectroscopy. The filtrate of the combined aliquots was analysed using HPLC.

The yield for the solid residue was 0.031 g. Ultimate analysis of the solid residues produced the following results: 46.8% carbon, 6.3% hydrogen, 0.1% nitrogen, 0.5% sulphur and 46.3% oxygen (by difference). In the aqueous solution, the yields were as follows: cellobiose 5.0%, glucose 4.3% and xylose 9.7%. The yields of glucose and cellobiose were with respect to the hexose fraction in the original biomass. Similarly, the yield of xylose was with respect to the pentose fraction in the original biomass.

### Example 26

Pinewood shavings were processed to a powder using a kitchen mixer. The powder was sieved and the particles under 250 μm were used as described below.

Pinewood shavings (10 g) were dispersed in diethyl ether (150 mL) and sulphuric acid (0.52 mL, 95-97%, a commercially available product from J T Baker, USA) was added dropwise. The suspension was stirred for 1 hour before the solvent was removed under reduced pressure. Further, the powder which had been impregnated with acid and dried (1 g) was milled for 3 hours in a steel bowl with steel balls (5 steel balls; individual weight 3.95 g) in a Pulverisette P7 from Fritsch. The rotational speed of the main disk was 800 rpm. A sample of the powder obtained was dissolved in water and examined using HPLC analysis. The powder obtained was completely water-soluble and produced a clear reddish-brown solution.

The powder obtained (0.9 g with acid) was dissolved in water (9 mL). The solution was heated for 1 hour to 80° C. The solid obtained thereby (lignin) was separated by filtration or centrifuging.

The solid was washed 6 times with 25 mL of water each time. The solid was then dried for 24 hours under vacuum at 60° C. The dry solid was weighed. The chemical composition of the solid was investigated by means of elemental analysis and infrared spectroscopy. The filtrate of the combined aliquots was analysed using HPLC.

The yield for the solid residue was 0.005 g. In the aqueous solution, the yields were as follows: cellobiose 3.1%, glucose 2.9% and xylose 8.4%. The yields of glucose and cellobiose were with respect to the hexose fraction in the original biomass. Similarly, the yield of xylose was with respect to the pentose fraction in the original biomass.

### Example 27

Pinewood shavings were processed to a powder using a kitchen mixer. The powder was sieved and the particles under 250 μm were used as described below.

Pinewood shavings (10 g) were dispersed in diethyl ether (150 mL) and sulphuric acid (0.52 mL, 95-97%, a commercially available product from J T Baker, USA) was added dropwise. The suspension was stirred for 1 hour before the solvent was removed under reduced pressure. Further, the powder which had been impregnated with acid and dried (1 g) was milled for 3 hours in a steel bowl with steel balls (5 steel balls; individual weight 3.95 g) in a Pulverisette P7 from Fritsch. The rotational speed of the main disk was 800 rpm. A sample of the powder obtained was dissolved in water and examined using HPLC analysis. The powder obtained was completely water-soluble and produced a clear reddish-brown solution.

The powder obtained (0.9 g with acid) was dissolved in water (9 mL). The solution was heated for 1 hour to 90° C. The solid obtained thereby (lignin) was separated by filtration or centrifuging.

The solid was washed 6 times with 25 mL of water each time. The solid was then dried for 24 hours under vacuum at 60° C. The dry solid was weighed. The chemical composition of the solid was investigated by means of elemental analysis and infrared spectroscopy. The filtrate of the combined aliquots was analysed using HPLC.

The yield for the solid residue was 0.279 g. Ultimate analysis of the solid residues produced the following results: 59.1% carbon, 6.1% hydrogen, 0.1% nitrogen, 0.8% sulphur and 33.9% oxygen (by difference). In the aqueous solution, the yields were as follows: cellobiose 5.3%, glucose 4.6% and xylose 10.7%. The yields of glucose and cellobiose were with respect to the hexose fraction in the original biomass. Similarly, the yield of xylose was with respect to the pentose fraction in the original biomass.

### Example 28

Pinewood shavings were processed to a powder using a kitchen mixer. The powder was sieved and the particles under 250 μm were used as described below.

Pinewood shavings (10 g) were dispersed in diethyl ether (150 mL) and sulphuric acid (0.52 mL, 95-97%, a commercially available product from J T Baker, USA) was added dropwise. The suspension was stirred for 1 hour before the solvent was removed under reduced pressure. Further, the powder which had been impregnated with acid and dried (1 g) was milled for 3 hours in a steel bowl with steel balls (5 steel balls; individual weight 3.95 g) in a Pulverisette P7 from Fritsch. The rotational speed of the main disk was 800 rpm. A sample of the powder obtained was dissolved in water and examined using HPLC analysis. The powder obtained was completely water-soluble and produced a clear reddish-brown solution.

The powder obtained (0.9 g with acid) was dissolved in water (9 mL). The solution was heated for 1 hour to 100° C. The solid obtained thereby (lignin) was separated by filtration or centrifuging.

The solid was washed 6 times with 25 mL of water each time. The solid was then dried for 24 hours under vacuum at 60° C. The dry solid was weighed. The chemical composition of the solid was investigated by means of elemental analysis and infrared spectroscopy. The filtrate of the combined aliquots was analysed using HPLC.

The yield for the solid residue was 0.276 g. Ultimate analysis of the solid residues produced the following results: 60.0% carbon, 6.2% hydrogen, 0.1% nitrogen, 0.6% sulphur and 33.2% oxygen (by difference). In the aqueous solution, the yields were as follows: cellobiose 4.9%, glucose 4.7% and xylose 15.5%. The yields of glucose and cellobiose were with respect to the hexose fraction in the original biomass. Similarly, the yield of xylose was with respect to the pentose fraction in the original biomass.

### Example 29

Pinewood shavings were processed to a powder using a kitchen mixer. The powder was sieved and the particles under 250 μm were used as described below.

Pinewood shavings (10 g) were dispersed in diethyl ether (150 mL) and sulphuric acid (0.52 mL, 95-97%, a commercially available product from J T Baker, USA) was added dropwise. The suspension was stirred for 1 hour before the solvent was removed under reduced pressure. Further, the powder which had been impregnated with acid and dried (1 g) was milled for 3 hours in a steel bowl with steel balls (5 steel balls; individual weight 3.95 g) in a Pulverisette P7 from Fritsch. The rotational speed of the main disk was 800 rpm. A sample of the powder obtained was dissolved in water and examined using HPLC analysis. The powder obtained was completely water-soluble and produced a clear reddish-brown solution.

The powder obtained (0.9 g with acid) was dissolved in water (9 mL). The solution was heated for 1 hour to 110° C. The solid obtained thereby (lignin) was separated by filtration or centrifuging.

The solid was washed 6 times with 25 mL of water each time. The solid was then dried for 24 hours under vacuum at 60° C. The dry solid was weighed. The chemical composition of the solid was investigated by means of elemental analysis and infrared spectroscopy. The filtrate of the combined aliquots was analysed using HPLC.

The yield for the solid residue was 0.262 g. Ultimate analysis of the solid residues produced the following results: 60.6% carbon, 6.0% hydrogen, 0.1% nitrogen, 0.3% sulphur and 33.0% oxygen (by difference). In the aqueous solution, the yields were as follows: cellobiose 11.7%, glucose 14.7% and xylose 45.9%. The yields of glucose and cellobiose were with respect to the hexose fraction in the original biomass. Similarly, the yield of xylose was with respect to the pentose fraction in the original biomass.

### Example 30

Pinewood shavings were processed to a powder using a kitchen mixer. The powder was sieved and the particles under 250 μm were used as described below.

Pinewood shavings (10 g) were dispersed in diethyl ether (150 mL) and sulphuric acid (0.52 mL, 95-97%, a commercially available product from J T Baker, USA) was added dropwise. The suspension was stirred for 1 hour before the solvent was removed under reduced pressure. Further, the powder which had been impregnated with acid and dried (1 g) was milled for 3 hours in a steel bowl with steel balls (5 steel balls; individual weight 3.95 g) in a Pulverisette P7 from Fritsch. The rotational speed of the main disk was 800 rpm. A sample of the powder obtained was dissolved in water and examined using HPLC analysis. The powder obtained was completely water-soluble and produced a clear reddish-brown solution.

The powder obtained (0.9 g with acid) was dissolved in water (9 mL). The solution was heated for 1 hour to 120° C. The solid obtained thereby (lignin) was separated by filtration or centrifuging.

The solid was washed 6 times with 25 mL of water each time. The solid was then dried for 24 hours under vacuum at 60° C. The dry solid was weighed. The chemical composition of the solid was investigated by means of elemental analysis and infrared spectroscopy. The filtrate of the combined aliquots was analysed using HPLC.

The yield for the solid residue was 0.262 g. Ultimate analysis of the solid residues produced the following results: 60.9% carbon, 6.0% hydrogen, 0.1% nitrogen, 0.2% sulphur and 32.7% oxygen (by difference). In the aqueous solution, the yields were as follows: cellobiose 18.5%, glucose 32.7% and xylose 79.1%. The yields of glucose and cellobiose were with respect to the hexose fraction in the original biomass. Similarly, the yield of xylose was with respect to the pentose fraction in the original biomass.

### Example 31

Pinewood shavings were processed to a powder using a kitchen mixer. The powder was sieved and the particles under 250 μm were used as described below.

Pinewood shavings (10 g) were dispersed in diethyl ether (150 mL) and sulphuric acid (0.52 mL, 95-97%, a commercially available product from J T Baker, USA) was added dropwise. The suspension was stirred for 1 hour before the solvent was removed under reduced pressure. Further, the powder which had been impregnated with acid and dried (1 g) was milled for 3 hours in a steel bowl with steel balls (5 steel balls; individual weight 3.95 g) in a Pulverisette P7 from Fritsch. The rotational speed of the main disk was 800 rpm. A sample of the powder obtained was dissolved in water and examined using HPLC analysis. The powder obtained was completely water-soluble and produced a clear reddish-brown solution.

The powder obtained (0.9 g with acid) was dissolved in water (9 mL). The solution was heated for 1 hour to 130° C. The solid obtained thereby (lignin) was separated by filtration or centrifuging.

The solid was washed 6 times with 25 mL of water each time. The solid was then dried for 24 hours under vacuum at 60° C. The dry solid was weighed. The chemical composition of the solid was investigated by means of elemental analysis and infrared spectroscopy. The filtrate of the combined aliquots was analysed using HPLC.

The yield for the solid residue was 0.238 g. Ultimate analysis of the solid residues produced the following results: 61.7% carbon, 6.3% hydrogen, 0.0% nitrogen, 0.2% sulphur and 31.7% oxygen (by difference). In the aqueous solution, the yields were as follows: cellobiose 14.2%, glucose 67.8% and xylose 88.4%. The yields of glucose and cellobiose were with respect to the hexose fraction in the original biomass. Similarly, the yield of xylose was with respect to the pentose fraction in the original biomass.

### Example 32

Pinewood shavings were processed to a powder using a kitchen mixer. The powder was sieved and the particles under 250 μm were used as described below.

Pinewood shavings (10 g) were dispersed in diethyl ether (150 mL) and sulphuric acid (0.52 mL, 95-97%, a commercially available product from J T Baker, USA) was added dropwise. The suspension was stirred for 1 hour before the solvent was removed under reduced pressure. Further, the powder which had been impregnated with acid and dried (1 g) was milled for 3 hours in a steel bowl with steel balls (5 steel balls; individual weight 3.95 g) in a Pulverisette P7 from Fritsch. The rotational speed of the main disk was 800 rpm. A sample of the powder obtained was dissolved in water and examined using HPLC analysis. The powder obtained was completely water-soluble and produced a clear reddish-brown solution.

The powder obtained (0.9 g with acid) was dissolved in water (9 mL). The solution was heated for 1 hour to 140° C. The solid obtained thereby (lignin) was separated by filtration or centrifuging.

The solid was washed 6 times with 25 mL of water each time. The solid was then dried for 24 hours under vacuum at 60° C. The dry solid was weighed. The chemical composition of the solid was investigated by means of elemental analysis and infrared spectroscopy. The filtrate of the combined aliquots was analysed using HPLC.

The yield for the solid residue was 0.241 g. Ultimate analysis of the solid residues produced the following results: 61.9% carbon, 6.3% hydrogen, 0.1% nitrogen, 0.2% sulphur and 31.5% oxygen (by difference). In the aqueous solution, the yields were as follows: cellobiose 6.6%, glucose 87.5% and xylose 98.8%. The yields of glucose and cellobiose were with respect to the hexose fraction in the original biomass. Similarly, the yield of xylose was with respect to the pentose fraction in the original biomass.

### Example 33

Pinewood shavings were processed to a powder using a kitchen mixer. The powder was sieved and the particles under 250 μm were used as described below.

Pinewood shavings (10 g) were dispersed in diethyl ether (150 mL) and sulphuric acid (0.52 mL, 95-97%, a commercially available product from J T Baker, USA) was added dropwise. The suspension was stirred for 1 hour before the solvent was removed under reduced pressure. Further, the powder which had been impregnated with acid and dried (1 g) was milled for 3 hours in a steel bowl with steel balls (5 steel balls; individual weight 3.95 g) in a Pulverisette P7 from Fritsch. The rotational speed of the main disk was 800 rpm. A sample of the powder obtained was dissolved in water and examined using HPLC analysis. The powder obtained was completely water-soluble and produced a clear reddish-brown solution.

The powder obtained (0.9 g with acid) was dissolved in water (9 mL). The solution was heated for 1 hour to 145° C. The solid obtained thereby (lignin) was separated by filtration or centrifuging.

The solid was washed 6 times with 25 mL of water each time. The solid was then dried for 24 hours under vacuum at 60° C. The dry solid was weighed. The chemical composition of the solid was investigated by means of elemental analysis and infrared spectroscopy. The filtrate of the combined aliquots was analysed using HPLC.

The yield for the solid residue was 0.235 g. Ultimate analysis of the solid residues produced the following results: 62.1% carbon, 6.2% hydrogen, 0.0% nitrogen, 0.3% sulphur and 31.4% oxygen (by difference). In the aqueous solution, the yields were as follows: cellobiose 4.2%, glucose 88.4% and xylose 97.2%. The yields of glucose and cellobiose were with respect to the hexose fraction in the original biomass. Similarly, the yield of xylose was with respect to the pentose fraction in the original biomass.

### Example 34

Pinewood shavings were processed to a powder using a kitchen mixer. The powder was sieved and the particles under 250 μm were used as described below.

Pinewood shavings (10 g) were dispersed in diethyl ether (150 mL) and sulphuric acid (0.78 mL, 95-97%, a commercially available product from J T Baker, USA) was added dropwise. The suspension was stirred for 1 hour before the solvent was removed under reduced pressure. Further, the powder which had been impregnated with acid and dried (1 g) was milled for 3 hours in a steel bowl with steel balls (5 steel balls; individual weight 3.95 g) in a Pulverisette P7 from Fritsch. The rotational speed of the main disk was 800 rpm. A sample of the powder obtained was dissolved in water and examined using HPLC analysis. The powder obtained was completely water-soluble and produced a clear reddish-brown solution.

The powder obtained (0.9 g with acid) was dissolved in water (9 mL). The solution was heated for 1 hour to 70° C. The solid obtained thereby (lignin) was separated by filtration or centrifuging.

The solid was washed 6 times with 25 mL of water each time. The solid was then dried for 24 hours under vacuum at 60° C. The dry solid was weighed. The chemical composition of the solid was investigated by means of elemental analysis and infrared spectroscopy. The filtrate of the combined aliquots was analysed using HPLC.

The yield for the solid residue was 0.006 g. In the aqueous solution, the yields were as follows: cellobiose 5.3%, glucose 4.3% and xylose 9.6%. The yields of glucose and cellobiose were with respect to the hexose fraction in the original biomass. Similarly, the yield of xylose was with respect to the pentose fraction in the original biomass.

### Example 35

Pinewood shavings were processed to a powder using a kitchen mixer. The powder was sieved and the particles under 250 μm were used as described below.

Pinewood shavings (10 g) were dispersed in diethyl ether (150 mL) and sulphuric acid (0.78 mL, 95-97%, a commercially available product from J T Baker, USA) was added dropwise. The suspension was stirred for 1 hour before the solvent was removed under reduced pressure. Further, the powder which had been impregnated with acid and dried (1 g) was milled for 3 hours in a steel bowl with steel balls (5 steel balls; individual weight 3.95 g) in a Pulverisette P7 from Fritsch. The rotational speed of the main disk was 800 rpm. A sample of the powder obtained was dissolved in water and examined using HPLC analysis. The powder obtained was completely water-soluble and produced a clear reddish-brown solution.

The powder obtained (0.9 g with acid) was dissolved in water (9 mL). The solutions were heated for 1 hour to 80° C. The solid obtained thereby (lignin) was separated by filtration or centrifuging.

The solid was washed 6 times with 25 mL of water each time. The solid was then dried for 24 hours under vacuum at 60° C. The dry solid was weighed. The chemical composition of the solid was investigated by means of elemental analysis and infrared spectroscopy. The filtrate of the combined aliquots was analysed using HPLC.

The yield for the solid residue was 0.003 g. In the aqueous solution, the yields were as follows: cellobiose 6.1%, glucose 5.1% and xylose 10.9%. The yields of glucose and cellobiose were with respect to the hexose fraction in the original biomass. Similarly, the yield of xylose was with respect to the pentose fraction in the original biomass.

### Example 36

Pinewood shavings were processed to a powder using a kitchen mixer. The powder was sieved and the particles under 250 μm were used as described below.

Pinewood shavings (10 g) were dispersed in diethyl ether (150 mL) and sulphuric acid (0.78 mL, 95-97%, a commercially available product from J T Baker, USA) was added dropwise. The suspension was stirred for 1 hour before the solvent was removed under reduced pressure. Further, the powder which had been impregnated with acid and dried (1 g) was milled for 3 hours in a steel bowl with steel balls (5 steel balls; individual weight 3.95 g) in a Pulverisette P7 from Fritsch. The rotational speed of the main disk was 800 rpm. A sample of the powder obtained was dissolved in water and examined using HPLC analysis. The powder obtained was completely water-soluble and produced a clear reddish-brown solution.

The powder obtained (0.9 g with acid) was dissolved in water (9 mL). The solution was heated for 1 hour to 90° C. The solid obtained thereby (lignin) was separated by filtration or centrifuging.

The solid was washed 6 times with 25 mL of water each time. The solid was then dried for 24 hours under vacuum at 60° C. The dry solid was weighed. The chemical composition of the solid was investigated by means of elemental analysis and infrared spectroscopy. The filtrate of the combined aliquots was analysed using HPLC.

The yield for the solid residue was 0.311 g. Ultimate analysis of the solid residues produced the following results: 59.7% carbon, 6.0% hydrogen, 0.1% nitrogen, 0.2% sulphur and 34.0% oxygen (by difference). In the aqueous solution, the yields were as follows: cellobiose 4.2%, glucose 4.5% and xylose 14.2%. The yields of glucose and cellobiose were with respect to the hexose fraction in the original biomass. Similarly, the yield of xylose was with respect to the pentose fraction in the original biomass.

### Example 37

Pinewood shavings were processed to a powder using a kitchen mixer. The powder was sieved and the particles under 250 μm were used as described below.

Pinewood shavings (10 g) were dispersed in diethyl ether (150 mL) and sulphuric acid (0.78 mL, 95-97%, a commercially available product from J T Baker, USA) was added dropwise. The suspension was stirred for 1 hour before the solvent was removed under reduced pressure. Further, the powder which had been impregnated with acid and dried (1 g) was milled for 3 hours in a steel bowl with steel balls (5 steel balls; individual weight 3.95 g) in a Pulverisette P7 from Fritsch. The rotational speed of the main disk was 800 rpm. A sample of the powder obtained was dissolved in water and examined using HPLC analysis. The powder obtained was completely water-soluble and produced a clear reddish-brown solution.

The powder obtained (0.9 g with acid) was dissolved in water (9 mL). The solution was heated for 1 hour to 100° C. The solid obtained thereby (lignin) was separated by filtration or centrifuging.

The solid was washed 6 times with 25 mL of water each time. The solid was then dried for 24 hours under vacuum at 60° C. The dry solid was weighed. The chemical composition of the solid was investigated by means of elemental analysis and infrared spectroscopy. The filtrate of the combined aliquots was analysed using HPLC.

The yield for the solid residue was 0.274 g. Ultimate analysis of the solid residues produced the following results: 60.9% carbon, 6.0% hydrogen, 0.1% nitrogen, 0.4% sulphur and 32.5% oxygen (by difference). In the aqueous solution, the yields were as follows: cellobiose 6.8%, glucose 8.3% and xylose 28.1%. The yields of glucose and cellobiose were with respect to the hexose fraction in the original biomass. Similarly, the yield of xylose was with respect to the pentose fraction in the original biomass.

### Example 38

Pinewood shavings were processed to a powder using a kitchen mixer. The powder was sieved and the particles under 250 μm were used as described below.

Pinewood shavings (10 g) were dispersed in diethyl ether (150 mL) and sulphuric acid (0.78 mL, 95-97%, a commercially available product from J T Baker, USA) was added dropwise. The suspension was stirred for 1 hour before the solvent was removed under reduced pressure. Further, the powder which had been impregnated with acid and dried (1 g) was milled for 3 hours in a steel bowl with steel balls (5 steel balls; individual weight 3.95 g) in a Pulverisette P7 from Fritsch. The rotational speed of the main disk was 800 rpm. A sample of the powder obtained was dissolved in water and examined using HPLC analysis. The powder obtained was completely water-soluble and produced a clear reddish-brown solution.

The powder obtained (0.9 g with acid) was dissolved in water (9 mL). The solution was heated for 1 hour to 110° C. The solid obtained thereby (lignin) was separated by filtration or centrifuging.

The solid was washed 6 times with 25 mL of water each time. The solid was then dried for 24 hours under vacuum at 60° C. The dry solid was weighed. The chemical composition of the solid was investigated by means of elemental analysis and infrared spectroscopy. The filtrate of the combined aliquots was analysed using HPLC.

The yield for the solid residue was 0.246 g. Ultimate analysis of the solid residues produced the following results: 61.3% carbon, 6.3% hydrogen, 0.1% nitrogen, 0.1% sulphur and 32.1% oxygen (by difference). In the aqueous solution, the yields were as follows: cellobiose 14.9%, glucose 20.1% and xylose 52.9%. The yields of glucose and cellobiose were with respect to the hexose fraction in the original biomass. Similarly, the yield of xylose was with respect to the pentose fraction in the original biomass.

### Example 39

Pinewood shavings were processed to a powder using a kitchen mixer. The powder was sieved and the particles under 250 μm were used as described below.

Pinewood shavings (10 g) were dispersed in diethyl ether (150 mL) and sulphuric acid (0.78 mL, 95-97%, a commercially available product from J T Baker, USA) was added dropwise. The suspension was stirred for 1 hour before the solvent was removed under reduced pressure. Further, the powder which had been impregnated with acid and dried (1 g) was milled for 3 hours in a steel bowl with steel balls (5 steel balls; individual weight 3.95 g) in a Pulverisette P7 from Fritsch. The rotational speed of the main disk was 800 rpm. A sample of the powder obtained was dissolved in water and examined using HPLC analysis. The powder obtained was completely water-soluble and produced a clear reddish-brown solution.

The powder obtained (0.9 g with acid) was dissolved in water (9 mL). The solution was heated for 1 hour to 120° C. The solid obtained thereby (lignin) was separated by filtration or centrifuging.

The solid was washed 6 times with 25 mL of water each time. The solid was then dried for 24 hours under vacuum at 60° C. The dry solid was weighed. The chemical composition of the solid was investigated by means of elemental analysis and infrared spectroscopy. The filtrate of the combined aliquots was analysed using HPLC.

The yield for the solid residue was 0.219 g. Ultimate analysis of the solid residues produced the following results: 61.4% carbon, 6.3% hydrogen, 0.1% nitrogen, 0.0% sulphur and 32.2% oxygen (by difference). In the aqueous solution, the yields were as follows: cellobiose 21.1%, glucose 51.6% and xylose 88.9%. The yields of glucose and cellobiose were with respect to the hexose fraction in the original biomass. Similarly, the yield of xylose was with respect to the pentose fraction in the original biomass.

### Example 40

Pinewood shavings were processed to a powder using a kitchen mixer. The powder was sieved and the particles under 250 μm were used as described below.

Pinewood shavings (10 g) were dispersed in diethyl ether (150 mL) and sulphuric acid (0.78 mL, 95-97%, a commercially available product from J T Baker, USA) was added dropwise. The suspension was stirred for 1 hour before the solvent was removed under reduced pressure. Further, the powder which had been impregnated with acid and dried (1 g) was milled for 3 hours in a steel bowl with steel balls (5 steel balls; individual weight 3.95 g) in a Pulverisette P7 from Fritsch. The rotational speed of the main disk was 800 rpm. A sample of the powder obtained was dissolved in water and examined using HPLC analysis. The powder obtained was completely water-soluble and produced a clear reddish-brown solution.

The powder obtained (0.9 g with acid) was dissolved in water (9 mL). The solution was heated for 1 hour to 130° C. The solid obtained thereby (lignin) was separated by filtration or centrifuging.

The solid was washed 6 times with 25 mL of water each time. The solid was then dried for 24 hours under vacuum at 60° C. The dry solid was weighed. The chemical composition of the solid was investigated by means of elemental analysis and infrared spectroscopy. The filtrate of the combined aliquots was analysed using HPLC.

The yield for the solid residue was 0.230 g. Ultimate analysis of the solid residues produced the following results: 62.4% carbon, 6.3% hydrogen, 0.0% nitrogen, 0.0% sulphur and 31.3% oxygen (by difference). In the aqueous solution, the yields were as follows: cellobiose 7.8%, glucose 86.3% and xylose 99.9%. The yields of glucose and cellobiose were with respect to the hexose fraction in the original biomass. Similarly, the yield of xylose was with respect to the pentose fraction in the original biomass.

The fractionated lignins were analysed by means of IR and elemental analysis (FIGS. 5 and 8). The results show that the carbon content of the precipitate rises with increasing hydrolysis temperature.

### Example 41

Beechwood shavings were processed to a powder using a kitchen mixer. The powder was sieved and the particles under 250 μm were used as described below.

Hydrogen chloride gas (99.8%, Air Liquide) was passed over beechwood shavings (5 g) for 15 min at normal pressure. Next, the product was degassed under vacuum (0.001 torr). Further, the powder which had been impregnated with acid and dried (1 g) was milled for 2 hours in a steel bowl with steel balls (5 steel balls; individual weight 3.95 g) in a Pulverisette P7 from Fritsch. The rotational speed of the main disk was 800 rpm. A sample of the powder obtained was dissolved in water and examined using HPLC analysis. The powder obtained was partially water-soluble (73%) and produced a clear reddish-brown solution.

The powder obtained (0.9 g with acid) was dissolved in water (9 mL). The solution was heated for 1 hour to 140° C. The solid obtained thereby (lignin) was separated by filtration or centrifuging.

The solid was washed 6 times with 25 mL of water each time. The solid was then dried for 24 hours under vacuum at 60° C. The dry solid was weighed. The chemical composition of the solid was investigated by means of elemental analysis and infrared spectroscopy. These analyses showed that the solid consisted of lignin. The filtrate of the combined aliquots was analysed using HPLC.

The yield for the solid residue was 0.207 g. Ultimate analysis of the solid residues produced the following results: 62.7% carbon, 6.0% hydrogen, 0.4% nitrogen, 0.0% sulphur and 30.8% oxygen (by difference). In the aqueous solution, the yields were as follows: cellobiose 7.2%, glucose 75.6% and xylose 87.9%. The yields of glucose and cellobiose were with respect to the hexose fraction in the original biomass. Similarly, the yield of xylose was with respect to the pentose fraction in the original biomass.

### Example 42

Sugarcane bagasse was processed to a powder using a kitchen mixer. The powder was sieved and the particles under 250 μm were used as described below.

Hydrogen chloride gas (99.8%, Air Liquide) was passed over beechwood shavings (5 g) for 15 min at normal pressure. Next, the product was degassed under vacuum (0.001 torr). Further, the powder which had been impregnated with acid and dried (1 g) was milled for 3 hours in a steel bowl with steel balls (5 steel balls; individual weight 3.95 g) in a Pulverisette P7 from Fritsch. The rotational speed of the main disk was 800 rpm. A sample of the powder obtained was dissolved in water and examined using HPLC analysis. The powder obtained was partially water-soluble (80%) and produced a clear reddish-brown solution.

The powder obtained (0.9 g with acid) was dissolved in water (9 mL). The solution was heated for 1 hour to 140° C. The solid obtained thereby (lignin) was separated by filtration or centrifuging.

The solid was washed 6 times with 25 mL of water each time. The solid was then dried for 24 hours under vacuum at 60° C. The dry solid was weighed. The chemical composition of the solid was investigated by means of elemental analysis and infrared spectroscopy. These analyses showed that the solid consisted of lignin. The filtrate of the combined aliquots was analysed using HPLC.

The yield for the solid residue was 0.150 g. Ultimate analysis of the solid residues produced the following results: 61.6% carbon, 5.6% hydrogen, 0.4% nitrogen, 0.0% sulphur and 32.4% oxygen (by difference). In the aqueous solution, the yields were as follows: cellobiose 5.0%, glucose 86.6% and xylose 97.6%. The yields of glucose and cellobiose were with respect to the hexose fraction in the original biomass. Similarly, the yield of xylose was with respect to the pentose fraction in the original biomass.

### BRIEF DESCRIPTION OF THE DRAWINGS

The present invention will now be illustrated further by the accompanying drawings, in which:

FIG. 1 shows the yields of cellobiose, glucose and xylose after hydrolysis at various temperatures of mechanically treated acid-impregnated beechwood.

FIG. 2 shows the yields of cellobiose, glucose and xylose after hydrolysis at various temperatures of mechanically treated acid-impregnated sugarcane bagasse.

FIG. 3 shows the yields of cellobiose, glucose and xylose after hydrolysis at various temperatures of mechanically treated acid-impregnated pinewood.

FIG. 4 shows the IR analysis of precipitates from the one-hour hydrolysis of mechanically treated acid-impregnated beechwood.

FIG. 5 shows the carbon content of precipitates after one-hour hydrolysis at different temperatures.

FIG. 6 shows the precipitates after one-hour hydrolysis at different temperatures.

FIG. 7 shows the IR analysis of precipitates from the one-hour hydrolysis of milled, acid-impregnated lignocelluloses, as well as Organosolv lignin from beechwood and untreated α-cellulose.

FIG. 8 shows the IR analysis of precipitates from the one-hour hydrolysis of mechanically treated, acid-impregnated sugarcane bagasse.

FIG. 9 shows the IR analysis of precipitates from the one-hour hydrolysis of mechanically treated, acid-impregnated pinewood.

FIG. 10 shows the process scheme for fractionation of plant biomass into water-soluble monosaccharides and lignins.

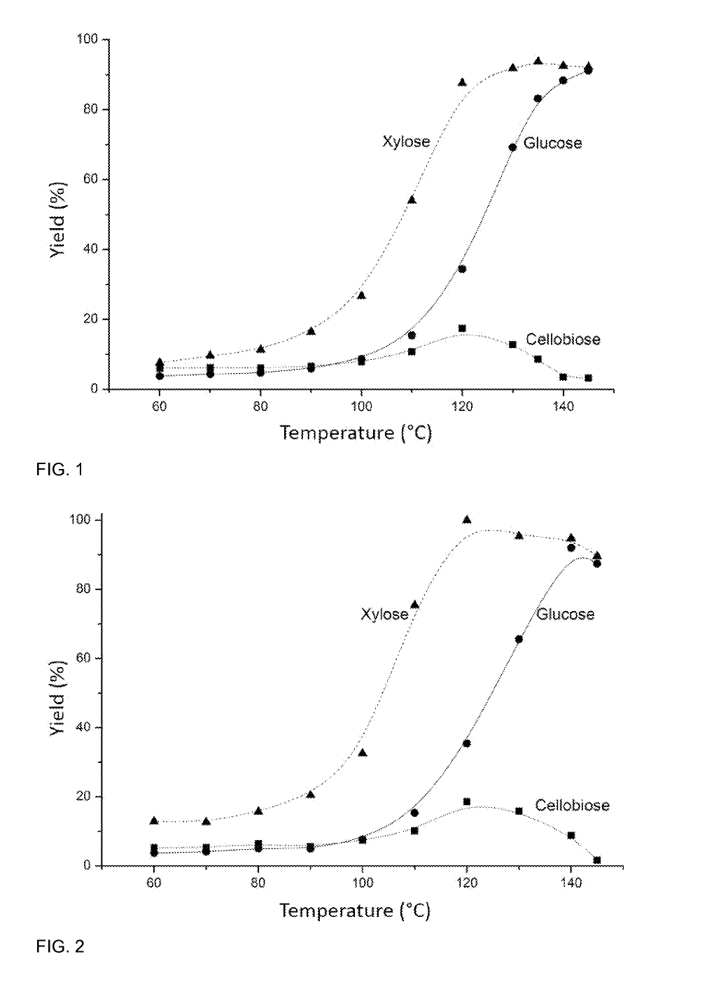

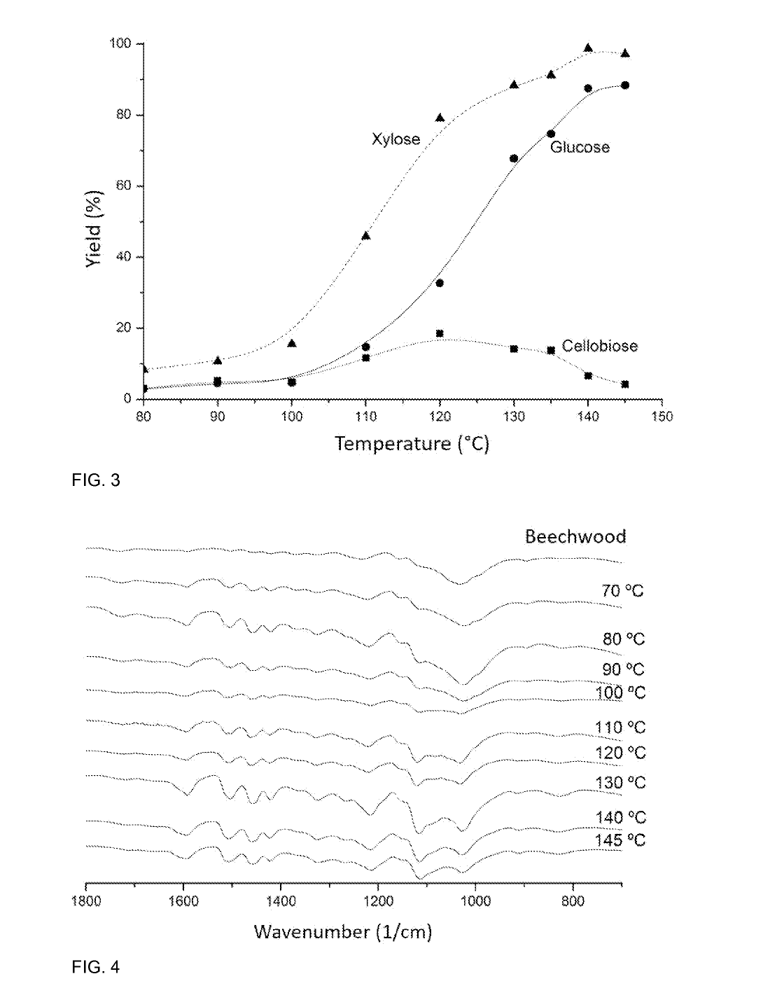

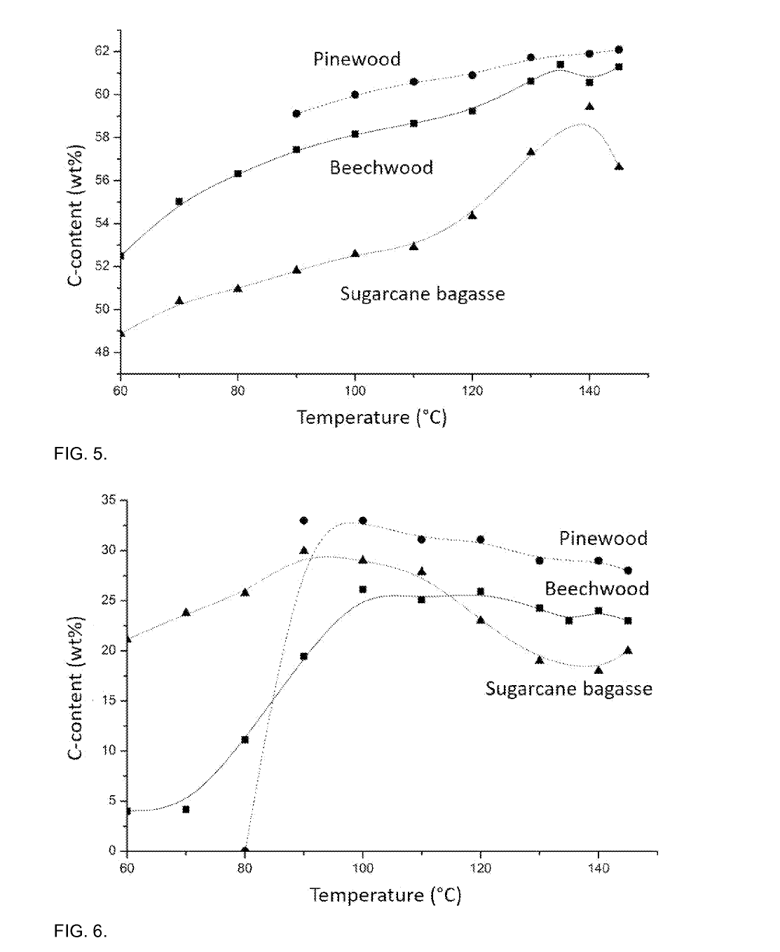

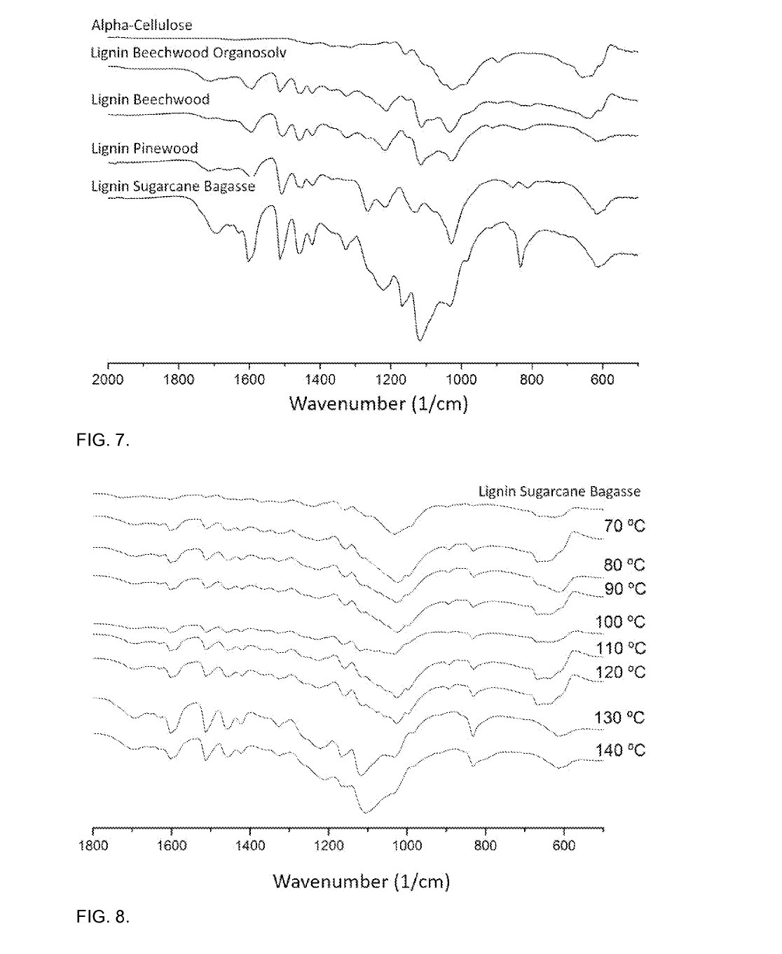

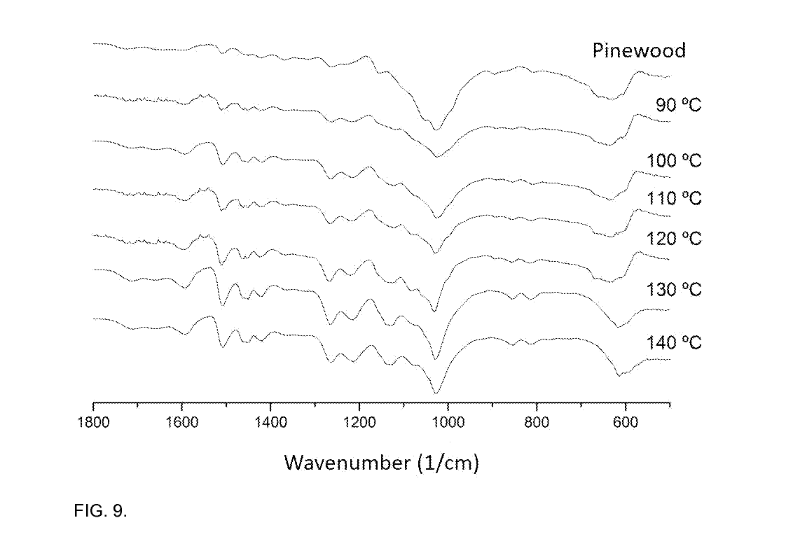

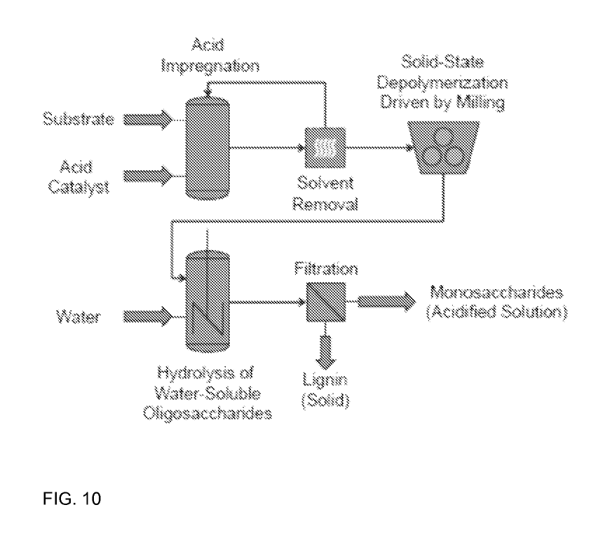

1. A process for digesting lignocellulosic biomass comprising (a) soaking lignocellulosic starting materials or impregnating with an acid in the liquid or gaseous phase, (b) bringing the starting materials which have been impregnated with acid and optionally dried into contact under the action of mechanical energy, wherein the mechanical treatment is carried out for at least the length of time required for more than 60% by weight of the degradation or decomposition products of the lignocellulosic material with respect to the lignocellulosic material used to be water-soluble, and (c) taking the digestion residue up in water, in a solvent which is miscible with water or in mixtures thereof, the dispersion/solution obtained optionally being heated to a temperature of more than 40° C. over a period of up to 24 hours.

2. The process as claimed in claim 1, in which further comprises (d) after heating, separating the dispersion/solution into water-soluble fractions and water-insoluble fractions.

3. The process as claimed in claim 1, wherein the acid has a pKa of −14 to 2.

4. The process as claimed in claim 1, in which the soaking is carried out with a solution of an acid in a liquid phase and the solvent is separated out after an exposure period.

5. The process as claimed in claim 1, in which the soaking is carried out with an acid in the gaseous phase.

6. The process as claimed in claim 1, in which the acid is used in a catalytic quantity.

7. The process as claimed in claim 1, wherein the mechanical treatment is a comminution of the material to be milled by milling, extruding, kneading and/or bombardment with high energy mechanical waves.

8. The process as claimed in claim 7, wherein the material to be milled is comminuted in a mill, optionally using milling bodies or ultrasound.

9. The process as claimed in claim 1, in which the material obtained after mechanical treatment undergoes a process step for neutralization of the acid.

10. The process as claimed claim 1, in which the digestion residue is taken up in water or in a solvent which is miscible with water, the obtained aqueous solution is heated, and the precipitated insoluble residue is separated out.

11. The process as claimed in claim 10, in which the obtained aqueous solution is heated to a temperature of more than 60° C. over a time period of 0.005 to 24 hours.
